(19) United States
(12) Patent Application Publication
(10) Pub. No.: US 2014/0136300 A1
(43) Pub. Date: May 15, 2014

(54) AUTHORIZED TRANSACTION INCENTED BY MERCHANT DONATION

(71) Applicant: Edatanetworks Inc., Edmonton (CA)

(72) Inventors: Terrance Patrick Tietzen, Edmonton (CA); Matthew Arnold Macpherson Bates, Edmonton (CA)

(73) Assignee: Edatanetworks Inc., Edmonton (CA)

(21) Appl. No.: 13/748,459

(22) Filed: Jan. 23, 2013

Related U.S. Application Data
(60) Provisional application No. 61/589,482, filed on Jan. 23, 2012.
(60) Provisional application No. 61/732,152, filed on Nov. 30, 2012.

(51) Int. Cl. G06Q 30/02

(52) U.S. Cl. CPC G06Q 30/0207; G06Q 30/0279
USPC 705/14.1

(57) ABSTRACT

A merchant incentivizes an account holder to make an authorized transaction by terms and agreement to auditably donate to the account holder's affinity entity. To incent desirable commerce with locals, the merchant's terms may limit its donation by a derivation of navigation time between account holder and merchant, and/or by date and time of the transaction. The account holder can direct the donation to one of more affinity entities within their own community, and/or within a community where the transaction was physically conducted. An account holds can also donate at the time of transaction where the donation is paid by the account's issuer for reimbursement as a debit to the account holder's account statement. Other payment system participants may donate (the merchant's acquirer, issuer, and transaction handler for the issuer and acquirer), by way of favorable interchange rates, can also make audible donations to account holder directed affinities entities.

### CROSS REFERENCE TO RELATED APPLICATIONS

This utility patent application claims priority to U.S. Provisional Application Ser. No. 61/589,482, titled “Open Loop Cashless Payment System Charitable Donations,” filed on Jan. 23, 2012, and to U.S. Provisional Application Ser. No. 61/732,152, titled “Customer Voice Order Triggered Mutual Affinity Merchant Donation,” filed on Nov. 30, 2012, which are incorporated herein by reference.

### FIELD

Implementations generally relate to an incentive by a merchant to encourage a consumer to make a purchase, and more particularly to the merchant providing the incentive of making a donation in exchange for the consumer conducting a transaction with the merchant on an account issued to the consumer by an issuer.

### BACKGROUND

Merchants often use techniques to prompt consumers into making a particular purchase. These techniques are commonly in the form of monetary incentives, relying on the principle that a lower price will result in increased sales. Merchants may employ these techniques, for example, to help clear inventory before a new season's merchandise is released, to ease the release of a new product, to increase sales near the end of the fiscal year, to compete with a competitor over particular products, or to generally spur sales. Monetary incentives may come in the form of a “sale” (i.e., temporary reduction in price at the register), a discount coupon, a mail-in rebate (i.e., a refund of part or the entire purchase price which is received by mail), or a store credit (i.e., credit that can be applied to another store purchase). These incentives usually only apply to a particular product and have a time component. For example, a sale may only apply to a particular brand of product purchased on a particular holiday weekend, and a rebate may only be valid for a particular product purchased within two weeks before the start of a school year.

Although consumers are typically incented to make purchases by a form of price reduction, non-monetary reasons also motivate consumers to make purchases with a merchant. For instance, the charitable actions by and intentions of a merchant may demonstrate to a consumer that the merchant is a force for good such that the consumer is non-monetarily incented to do business with the merchant who the consumer deems worthy of such support. As such, it would be an advance in the relevant arts to develop non-monetary incentive methodologies that will motivate a consumer to conduct a transaction with a merchant.

A problem for small to mid-sized merchants is that discount offers and rebates require time and attention at a Point of Service terminal (POS) at a brick and mortar store in order to ensure compliance with terms and conditions of the offer or rebate. The terms and conditions may require checks and verifications at the POS that include, date and time compliance with an offer or rebate, as well as product-specific data checks and verifications such as by examining Level 3 data, Stock Keeping Unit (SKU) data, serial number data, etc. Smaller merchants rarely have surplus time, neither at the POS nor post-transaction, to properly manage such checks, verifications, data tracking and administrations of these kinds of discounts and rebates. Accordingly, it would be an advance in the relevant arts to provide a system of incentives to consumers to conduct transactions with merchants, where the system requires little or no time of the merchant's time to be spent at the POS for the merchant to make good on the incentive to the customer.

Another problem for merchants, especially small to mid-sized merchants, is that an increasing number of transactions are conducted online with larger sized merchants instead of inside the brick and mortar stores of small to mid-sized merchants. Online transactions conducted with larger merchants can represent a loss in sales to traditional small and medium size merchants whose main business method tends to be attracting sales is a traditional retail, brick and mortar store environment, instead of by mail orders, telephone orders, and/or electronic commerce (e-commerce) transactions. The loss of the in-store purchase is a lost opportunity for the local merchant and local customer to build a sense of community by getting to know each other, personally, and a lost opportunity for the local customer to become a live advertisement for the merchant's retail store and its wares and services. Online sales also deny the traditional brick and mortar merchant an opportunity to sell customers in the retail environment best understood by the merchant. The loss of in-store purchases to online sales causes economic problems for traditional small and medium size merchants and the communities they serve. In some North American neighborhoods the number of small retail shops has dramatically declined, leaving traditional community commercial areas in a state of blight and disuse.

In addition to economic downturn sensitivities, small, family-owned stores also face extinction threats from sophisticated online retailers, with resultant losses to local community retail diversity and neighborhood health with the death of the neighborhood ‘mom-and-pop’ store. Neighborhood streets can seem vacant during the day and open only after 5 p.m. to serve the interests of only one demographic, namely young urban professionals with disposable income. Previously successful North American businesses have been closing when e-commerce competition from online auctions and retailers attract previously loyal neighbors. Accordingly, it would be an advance in the art of commerce to provide a system of incentives to neighborhood customers to engage in neighborhood brick and mortar, in-person transactions. It would be a further advance in the art of commerce to provide a system that gives incentives to customers to conduct transactions in the brick and mortar stores of neighborhood merchants so as to bring sales revenue into the neighborhood merchants and away from electronically competing, non-local merchants. It would be a still further advance in the art of commerce to provide a system that shifts sales tax revenue towards neighborhood authorities that would otherwise be lost to e-commerce transactions. It would also be an advance in the art of commerce to provide a system that incents local merchants in the community to receive foot traffic both from customers shopping with the merchant as well as incidentally from shoppers doing in-person shopping with other brick and mortar merchants. A yet further advance in the art of commerce would be to provide a system that provides an incentive to a customer, who would have otherwise only window-shopped a product at the brick and mortar store of a local merchant but then buy that product on-line from an electronic competitor merchant, to buy that product at the brick and mortar store of the local merchant.

### SUMMARY

One or more implementations relate to computer-implemented methods and server-implemented methods where, for each transaction between an account holder and a merchant, information is received that is derived from an authorization response for the transaction, where the information includes the date and the time, a currency amount, and an identifier for the merchant. For each transaction for which the date and time of the corresponding authorization response are within a predetermined time period, and for each identifier for the merchant, there is a deriving of the sum of the currency amounts by using the identifier for the merchant to access a database to retrieve (i) the logical address for the merchant, or its agent, corresponding to the identifier for the merchant and (ii) a business rule for making a donation corresponding to an identifier for an affinity entity or charity having a logical address, wherein in the currency amount of each donation is a function, at least in part, of the currency amount of each transaction. A transmission is made to the logical address for the merchant, or its agent, that includes the donation to the affinity entity or charity for the predetermined time-period. Within a predetermined audit time-period for and after the predetermined time-period, a plurality of donation receipts are received, each including (i) the respective identifiers for the affinity entity or charity and the merchant and (ii) a currency amount. For each identifier for the merchant, the sum of the currency amounts of the donation receipts for each identifier for the affinity entity or charity is derived.

After the predetermined audit time-period for the predetermined time, for each identifier for the merchant, and for each identifier corresponding to each affinity entity or charity to whom a donation was to be made as per the retrieved business rule, a determination is made of a difference between: (i) the donation for the predetermined time period that was transmitted to the logical address of the merchant, and (ii) the sum of the currency amounts of the donation receipts received for the affinity entity or charity for the predetermined time period. Then, the determined difference is transmitted to the logical address for the merchant, or its agent.

In various implementations, an account issued by an issuer to an account holder can be a revolving credit account, a debit account, a charge account, an Automatic Teller Machine (AMT) account, a prepaid account, a gift account, etc.

In other implementations, the affinity entities to which the merchant donates can be limited to those within the merchant's community, within the account holder's community, within both communities, or within neither community. In still further implementations, the account holders can designate those affinity entities to which the merchant is to make a donation, regardless of the location or charitable object or mission of the affinity entity. In yet other implementations, an acquirer for the merchant to a transaction can make the donation on the merchant's behalf incident to clearing and settling the transaction with the issuer that issued the account to the account holder, and where, optionally, the acquirer's donation can be in the form of an adjustment to exchange rate assessed to the merchant against the transaction amount for conducting the transaction on the account holder's account. Other participants in a payment processing system, including the issuer and the transaction handler, can similarly make donations as further incentives to the account holder to conduct a transaction on the account holder's account.

In still further implementations, in an open loop cashless payment system for making charitable donations, the merchant funds and makes direct payment of all donations to the merchant's designated affinity entities or charities according to a merchant designated business rule, wherein, in a variation thereof, the merchant funds and makes direct payment of all donations to merchant's designated affinity entities or charities that are located in, and/or provide services to, the merchant's neighborhood, which may be defined geographically or by other definitions.

In yet further implementations, in an open loop cashless payment system for making charitable donations, the merchant funds and the merchant's acquirer makes direct payment, incident to a process of closing and settlement, of all donations to all affinity entities or charities for those transaction conducted by account holders with the merchant on respective accounts issued to the account holder by respective issuers.

In still further implementations, in an open loop cashless payment system for making charitable donations, the merchant funds the charitable donations and the merchant's acquirer makes direct payment, incident to a process of closing and settlement, of all donations to all charities for those transaction conducted by the account holders with the merchant on respective accounts issued to respective account holders by respective issuers, wherein, in a variation thereof, the donations are made to those affinity entities or charities having a physical location within the merchant's neighborhood, which may or may not be a geographically defined community.

In yet further implementations, the merchant funds and makes direct payment of donations to account holder-designated charities for those transactions conducted by the account holder with the merchant.

In still further implementations, in an open loop cashless payment system for making charitable donations, the merchant funds and makes direct payment of all donations to all account holder designated charities for those transactions conducted by the account holder with the merchant on an account issued to the account holder by an issuer, wherein, in a variation thereof, the donations are made to those charities having a physical location within the merchant geographically defined community.

In still further implementations, in an open loop cashless payment system for making charitable donations, both the merchant and its acquirer fund donations to charities, incident to a process of closing and settlement, of all donations to all account holder designated charities for those transaction conducted by the account holder with the merchant on an account issued to the account holder by an issuer, wherein, in a variation thereof, the donations are made to those charities designated by the account holder, which charities may have a physical location within a neighborhood where the account holder resides and the merchant's brick and mortar store is located. In a still further variation thereof, a downward adjustment is made to an exchange fee assessed to the merchant by the merchant's acquirer such that the merchant is able to pay a lower exchange fee to compensate for the merchant's charitable contribution, and, optionally, the acquirer for the transaction can also pay the same local charities a donation out of increased transaction volume due to the incentive.

In yet further implementations, in an open loop cashless payment system for making charitable donations, the merchant funds and its acquirer makes direct payment, incident to a process of closing and settlement, of all donations to all account holder designated charities for those transactions conducted by the account holder with the merchant on an account issued to the account holder by an issuer, wherein the account holder matches at least a portion of the merchant's contribution to the affinity entity or charity by the account holder's issuer making direct payment to that affinity entity or charity incident to a process of closing and settlement such as by way of a charge for the account holder's charitable donation that is rendered as a statement debit on the account holder's periodic revolving credit account statement.

Variations on the foregoing implementations include allowing the customer to specify one or more affinity entities (e.g., charities) that provide goods and/or services in their local community to which donations are to made by merchants with whom the customer conducts transactions. In such implementations, each merchant is given notice of its total periodic obligatory donations. Such notice, however, is given without providing the merchant with any notice or knowledge as to the specific identity of those affinity entities that are to be its recipients. Such implementations leave the direction of merchant's donations fully within the discretion of the merchant's customers. In some implementations, the customer's discretion can be limited by the restriction that the customer can only select affinity entities from among those that serve the local community in common to both the merchant and the customer, while leaving the actual amount of the merchant's donation fully within the discretion of the merchant. Variations on such implementations include alternative definitions for the local community in common to both the merchant and the customer.

Still further variations on the foregoing implementations include deriving a donation to be made by the merchant to the affinity entity for a predetermined time-period by using a merchant donation business rule as well as a rule previously specified by the account holder who conducts the transaction with the merchant. By way of example, and not by way of limitation, the merchant's donation business rule might choose the amount of the donation whereas the account holder's rule might choose the affinity entity that is not located in the same community or either the merchant of the account holder.

It will be appreciated that the foregoing summary merely describes exemplary implementations to which claimed subject matter is not limited.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIGS. 1-2 are flowcharts illustrating respective exemplary processes that allow an account holder to make a purchase of goods and/or services from a merchant, where the account holder's transaction obligates the merchant to make a donation an affinity entity that make also be a charitable organization (e.g., a charity);

FIG. 3 illustrates an exemplary payment processing system in which the processes of FIGS. 1-2 can be performed, where the system processes transactions conducted by merchants with account holders, wherein, for each transaction, there is a provision of a service and/or good by the merchant to the account holder for the transaction which is conducted on an account issued to the account holder by an issuer, there is an authorizing and remunerating of an electronic payment by the account holder in conducting the transaction on the account with the merchant, and there are one or more donations by the merchant that are made to respective affinity entities or charities incident to the transaction;

FIGS. 4a-4b illustrate screen shots characterizing exemplary user interfaces for a merchant to designate terms and conditions under which the merchant will make a donation incident to each transaction with each account holder;

FIGS. 5a-5b illustrate screen shots characterizing exemplary user interfaces for an account holder to specify one or more affinity entities to whom a donation will be made by a merchant with whom the account holder conducts a transaction on an account issued to the account holder, and optionally also for the account holder to specify one or more affinity entities to whom a donation by the account holder will be made when the account holder conducts a transaction with the merchant on their account so as to match at least a portion of the donation by the merchant;

FIG. 6 illustrates exemplary systems housed within an interchange center to provide online and offline transaction processing for transactions conducted using the payment processing system illustrated in FIG. 3; and

FIG. 7 illustrates further exemplary details of the systems illustrated in FIG. 6.

Implementations will become more apparent from the detailed description set forth below when taken in conjunction with the drawings.

### DETAILED DESCRIPTION

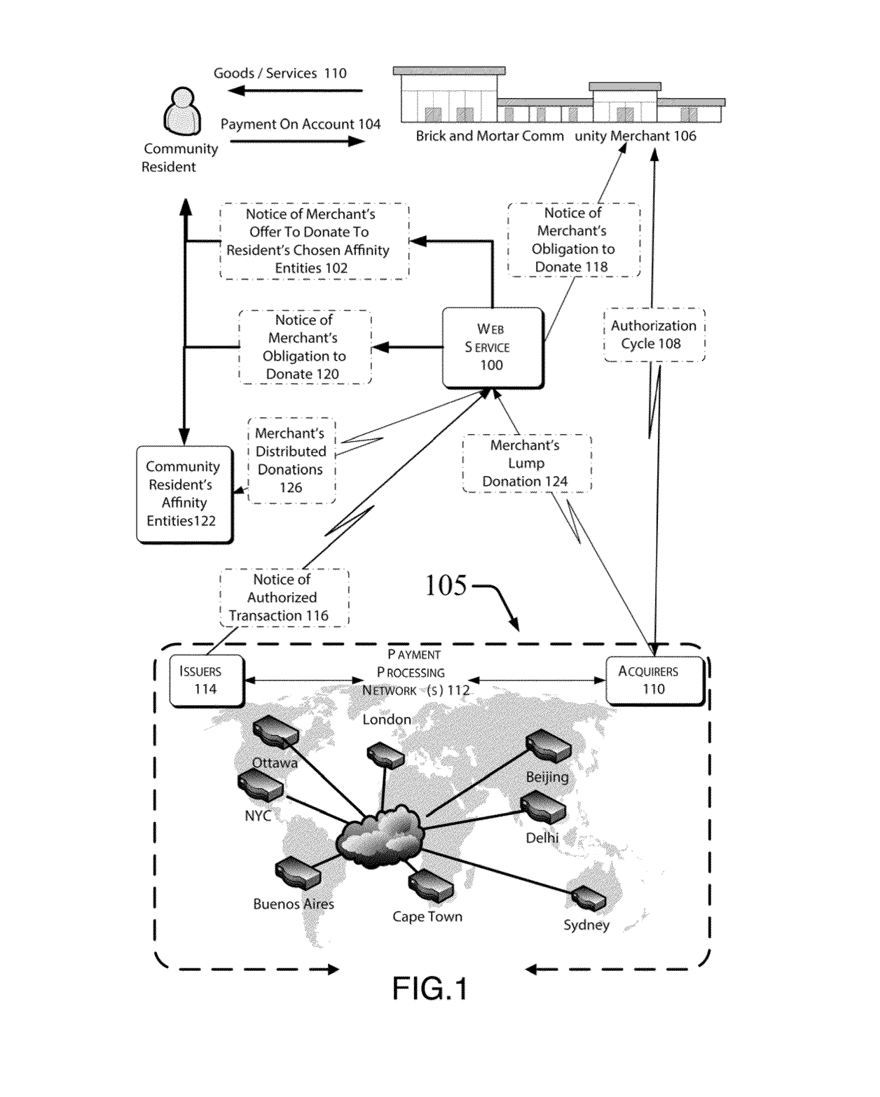

Referring now to FIG. 1, an environment is depicted for a global acquired account payment processing system 105 as shown. FIG. 1 shows a community resident who is incentivized to transact by way of a merchant's offer 102 to a make a donation in exchange for the community resident purchasing goods and services 100 by the community resident's payment on an account 104 that was issued by an issuer 114 to the community resident. Note that, in some implementations, the merchant sets terms and conditions under which the donation will be made, while the community resident selects those affinities entities to which the merchant's donations are to be made.

The merchant, who may be operating a brick and mortar store in the community where the community resident resides, inputs data about the transaction on the community resident's account into a Point of Service terminal (POS) 106. The POS, for example, can be a cash register, a web enable mobile device (e.g., a tablet computing device), etc. The POS 106 transmits the input data, as part of an authorization request in an authorization cycle for the transaction, to an acquirer 110 for the merchant. Acquirer 110, who is one of many entities in an Acquired Account Payment Processing System 105, sends the authorization request through a payment-processing network 112, as facilitated by one or more transaction handlers, to the issuer 112 who issued the account to the community resident. In response to the authorization request, the issuer 112 sends an authorization response for ultimate delivery back to the merchant's POS 106 by transmissions backwards through the payment-processing network 112 via the merchant's acquirer 110.

If the transaction is authorized by issuer 114, an entity in the Acquired Account Payment Processing System 105, such as the issuer 114, sends a message 116 containing particulars of the transaction to a Web Service 100 indicating that a transaction on the community resident's account was approved for being conducted by the community resident with the merchant whose offer to donate was selected by the community resident.

Optionally, the data input into POS 106 can include additional monies received from the customer by the merchant that are also to be donated, via the merchant, to a designated affinity entity or charity. In that case, message 116 would also contain these particulars.

Upon receipt of message 116, a donation to the community affinity entity by the user's selected merchant can be calculated according terms and conditions specified by the merchant.

Web Service 100 retains the derived donation for subsequent audit purposes to insure compliance by each community merchant in its donation commitments to each of the one or more affinity entities or charities. The Web Service 100 may transmit a message containing notice of a donation, or the particularly derived donation, as shown at reference numerals 118-120 to respective logical addresses of the obligated merchant 106, the affinity entities 122, and the community resident/account holder—and/or to respective agents thereof. The terms and conditions that obligate the merchant-offeror to make a donation may, but need not, include discounts, rebates, or other monetary or non-monetary incentives. As such, the community resident is incentivized to buy from the merchant's store at least by the merchant's agreement to donate to an affinity entity or charity.

The affinity entity or charity, which may be selected at the discretion of the community resident, may be any entity to which the community resident has an affinity, regardless of where it is located or whom it serves. Alternatively, the affinity entity or charity may be limited to those organizations that provide a good and/or service to a community in which both community residences and merchants have an affinity—such as by their common geographic location. This affinity entity may provide food and clothing to needy families in their common community. This affinity entity, for example, may provide teaching and demonstrations of entrepreneurial skills to community's unemployed or under employed. Another affinity entity may provide venues where sports education can be provided to local competing youth. Yet another affinity entity may provide care and feeding to abandoned domesticated animals, such as pets. The affinity entity may also cultivate desirable citizenship and public policy through offerings of education and entertainment services—whether in person, on-line, or both. Given the foregoing, the reader will understand that the affinity entity can be either a for-profit or a non-profit organization, and may optionally be required to provide a good or a service to a local community to which both merchants and customers in the same community have an affinity, by their common location, to advance and/or promote the community.

In some implementations, each merchant will identity the affinity entity to whom the merchant-offer will make a donation. To identify the affinity entity, a customer identifier, as received by Web Service 100 in message 116, will look up the community where the customer resides and where the merchant-offer has a brick and mortar store. Web Service 100 uses information in or derived from message 116 to determine whether the merchant and its customer have the same local community. By way of example, data in message 116 can include an identifier for the customer, and a database of merchants and their respective merchant-offers can include geographic location information. This geographic location information is matched against the geographic location information for the residence of the customer. Merchant and customer identifiers can be assigned to the merchant and its customer during or prior to any transaction, such as when each are registered with or otherwise sign up for participation with Web Service 100. This registration process can include the collection of physical and logical addresses for each or for their respective agents.

Once physical address information for the merchant-offeror and its customer are known, the local community of each of the merchant and its customer can be determined—in some implementations. The local community determination can be made on any of several different methods, or combinations thereof. Once such method is a political or legal division, that is, the merchant's place of business is determined to be in the same political or legal division as that of its customer's residence, such as the same province, state, county, prefecture, city, city-state, borough, etc. Another such comparison can be whether the merchant's place of business has a governmentally issued postal code that is the same, or within a predetermined proximity, as that of its customer's residence.

Yet another such comparison can be whether the merchant's place of business and its customer's residence are physically proximate within a predetermined factor by any of a variety of measures or combinations thereof. For example, latitude and longitude coordinates might be known for both the merchant's place of business and the residence of its customer. These coordinates can be used to determine whether the linear distance there between is within a predetermined distance to ascertain whether or not the merchant and its customer share the same local community.

Alternatively, a navigation algorithm, using any of various different travel methods (e.g., walking, automobile, bicycle, mass transit, etc.), can be used to determine whether the time, using one or more travel methods, is within a predetermined time limit to ascertain whether or not the merchant and its customer share the same local community or ‘neighborhood’. By way of example, the merchant and its customer might be determined to be within the same local community if the automobile drive time, as determined from one or more databases of contemporary cartographic road system information, to navigate between the merchant's brick and mortar store and the customer's residence is less than a predetermined time threshold (e.g., 17 minutes).

A further alternative implementation will identify the population density of both the merchant's brick and mortar store and the customer's residence. If the population density exceeds a predetermined density, then the merchant and its customer might be determined to be within the same local community if the time to walk, bicycle or take public transportation between the merchant's brick and mortar store and the customer's residence, as determined from one or more databases of contemporary topographic, mass transit, and/or pedestrian cartographic system information, is less than a predetermined time threshold (e.g., 55 minutes). Such implementations may also access databases to consider real time traffic conditions.

Still another such comparison can be whether the merchant's place of business and its customer's residence are proximate or are the same according to voting, electoral, or political districts. The district use can be determined by an official method, an unofficial method, or a combination of methods. By way of example, measurements known within the political gerrymander sciences can be used, including but not limited to a minimum district to convex polygon ratio, shortest split line algorithm, minimum isoperimetric quotient, etc.

The local community corresponding to that of the merchant and its customer, and separations there between (if any), can be determined from any combination of linear distance, mode-specific navigational transportation travel time, political separation, postal designation, and/or hybrid algorithm that takes into considers geographic barrier features such as rivers, cliffs, and highways, cultural features such as boundaries of identified people groups (e.g., tribes, first nation people, etc.), land ownership such as subdivisions, housing projects, cooperatives, planned communities, military installations, governmental owned and leased properties, etc. Given the foregoing, an algorithm might find that the merchant and its customer are members of the same community, not members of the same community, or are both members of more than one of the same communities as determined by the algorithm.

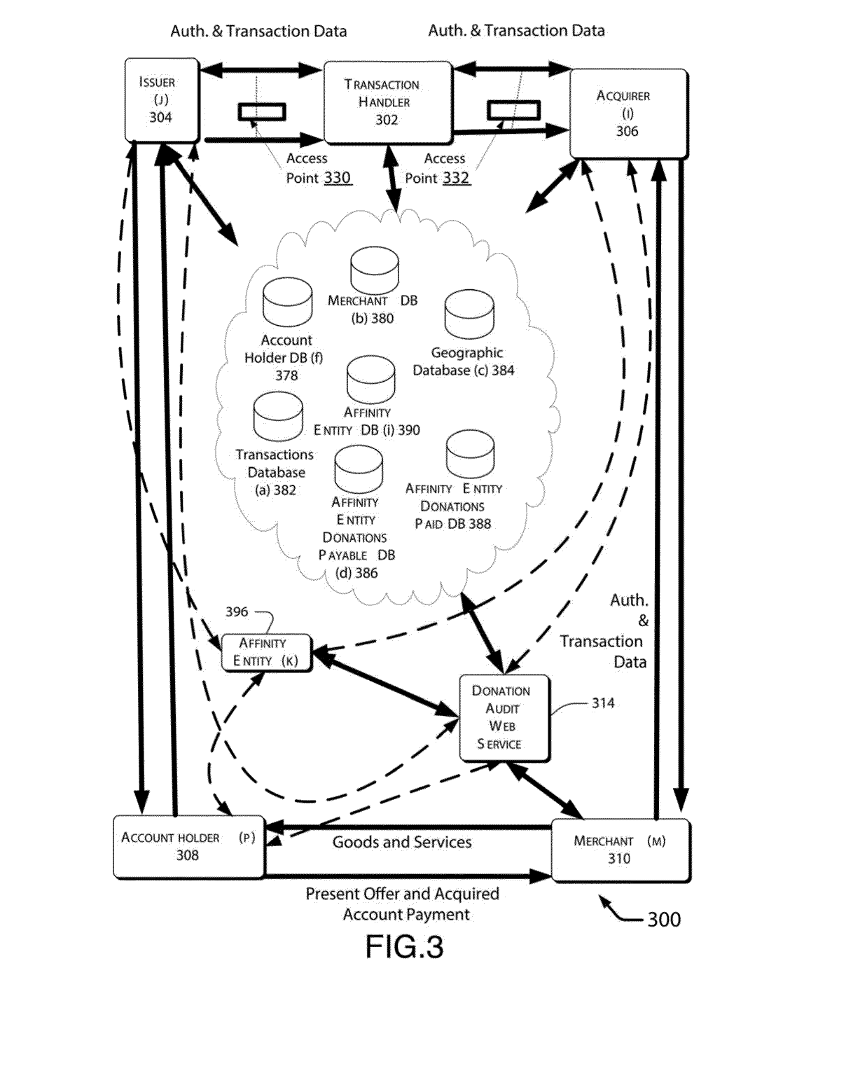

Similar or different algorithms that are used to determine the respective local community of the merchant and its customer can also be used to determine the local community of an affinity entity such as that shown on FIG. 1 at reference numeral 122, or as that shown as an Affinity Entity (k) 396 in FIG. 3, as discussed herein below.

In some implementations, if the local community of the merchant, its customer, and an affinity entity that has been selected by the customer or by other methods are the same, then the business rule selected by the merchant will determine the amount of the donation that the merchant will make to the selected affinity entity. In some implementations, the affinity entity to whom a merchant is to make a donation can only be selected the customer, and not the merchant. In such implementations, the goals or purposes of an affinity entity will not cause tension between merchant and customer in that the identity of the affinity entity is unknown to the merchant though being selected anonymously by the customer. As such, the merchant need not be told or be given any notice, directly or indirectly, as to the identity of the affinity, entity or charity selected the customer with whom the merchant is conducting a transaction. Rather, the merchant might only be told or be given notice to make a single payment of, or period payments to, a single affinity entity who, as trustee or agent, will thereafter make respective disbursements for all registered merchants accordingly to those affinity entities that had been selected those customers with whom those merchants had conducted transactions.

Various implementations can ensure that a merchant who, by force of reason or conscience, does not want to make a donation to a particular affinity entity or charity, need not do so directly, as any and all merchant donations are made blindly through other avenues or collection points that make all merchant donation disbursements to all affinity entities or charities. Accordingly, each merchant will have notice of its total periodic donations without knowing the identity of the intended recipients, thereby leaving the direction of donations fully within the discretion of the merchants' customers. Note that a limitation can optionally placed upon the customer's choice of affinity entity or charity such that the choice must be made only among those affinity entities or charities that serve the local community of the merchant, its customer, or both. Such implementations may leave the currency amount of the merchant's donation fully within the discretion of the merchant.

Web Service 100 can use respective identifiers for the merchant and its customer (e.g., account holder) to access and retrieve geographic information for each, and then apply an algorithm to the retrieved geographic information to determine the respective local communities of the merchant and its customer, as discussed above. By way of example, the local community can be progressively granular in nature, such as: 1^{st} the United States of America; 2^{nd} the state of New York; 3^{rd} the portion of New York called “Long Island”; 4^{th} the county of Nassau within the state of New York; 5^{th} a portion of the Nassau County called North Hempstead; and then 6^{th} the specific geographic location of “Port Washington”. This final level of geographic granularity indicates a community in which both merchant and customer are members, neighbors, residents, and/or the like.

The final level of geographic granularity can be used to perform a look-up against one or more databases to which Web Service 100 has access. This access and lookup is used by Web Service 100 to identify: (i) the affinity entity or charity for that community which, in this example, might be the Port Washington Food Bank located in Port Washington, N.Y., which charity might have been specified by the customer; and (ii) the respective identifier of the merchant's business rule (and/or the customer's business rule) that is to be used to make a calculation of the currency amount of the donation that the merchant is to make to the affinity entity or charity for that community. Business rule(s) is/are used with the currency amount of the customer's payment in order to calculate the currency amount of the donation that is to be made by the merchant to the affinity entity or charity for that community. Note that the donation can be directed to a plurality of affinity entities for the local community according to directions that had been previously specified by the customer. For example, the customer may have specified that each merchant donation is to be split evenly, or in specified portions totaling one hundred percent (100%), between five (5) local community affinity entities, for example: (i) a local youth sports team cooperative; (ii) a local charter junior high school; (iii) a local house of worship; (iv) a local political party; and (v) a local for-profit college specializing business entrepreneurialism.

Referring now to FIG. 1, the community resident can take the merchant's conditional offer 102 to the local merchant's brick and mortar store POS 106. After showing the offer 102 to the merchant at the POS 106, the community resident conducts a transaction on an account 104 issued by an issuer to the community resident to pay of the transaction and buy goods and/services 110 received by the community resident.

Note that terms and conditions of the transaction may differ from that of the offer presented by the community resident at the local merchant's brick and mortar store. As such, the merchant's offer to donate might not be specific to a particular good or service, but can be specific as to the entire transaction between the merchant and its customer. By way of example as to this type of offer specificity, the offer may obligate the merchant to make a donation of a certain percentage of the entire currency amount of transaction, or the offer may obligate the merchant to make a donation only if the transaction is conducted at a certain time of day or on a particular day of the week, or only if the currency amount of the transaction exceeds a predetermined amount, or a combination of the foregoing.

Although some terms of the offer may differ from some terms of subsequent transactions between the merchant and its customer, nevertheless, the merchant's offer to make a donation to an affinity entity (e.g., a local charity) fundamentally provides an incentive that causes, at least in part, the local community resident to navigate to the local merchant's brick and mortar store, come into the store, shop, and ultimately conduct a transaction that will bring revenue to the local merchant and its community. Advantageously, the absence of specificity in the offer as to a particular good or service allows many implementations to operate without modification to the merchant's input of data about the transaction at the POS 106, without modifications to the POS 106 itself, and without modifications to software executing on POS 106.

Optionally, a community resident (e.g., customer) may accept the merchant's offer 102 in advance of going to the POS 106. Such advance acceptance may take place electronically, such as in response to the community resident's electronic receipt of offer 102. Such an electronic acceptance to offer 102 can be by way of a transmission of information from the community resident to the merchant. The transmitted information can include: (i) an identifier for the registered customer who intends to accept the merchant's offer 102; (ii) the calculated distance and/or time for the customer to navigate from a geographic location associated with the customer (e.g., home location, work location, vacation location, etc.) to the merchant's brick and mortar store of the POS 106 by walking, bicycling, automobile and/or mass transit; (iii) the terms and conditions of the offer including any expiration thereof; (iv) optionally any other information already conveyed to the customer, such as a statement about the donation that the merchant will make to the Affinity Entity(ies) 122 when the customer conducts a timely transaction with merchant; and (v) other unexpired offers or advertisements that may or may not have been conveyed to the customer, terms and conditions of such other offer(s), etc.

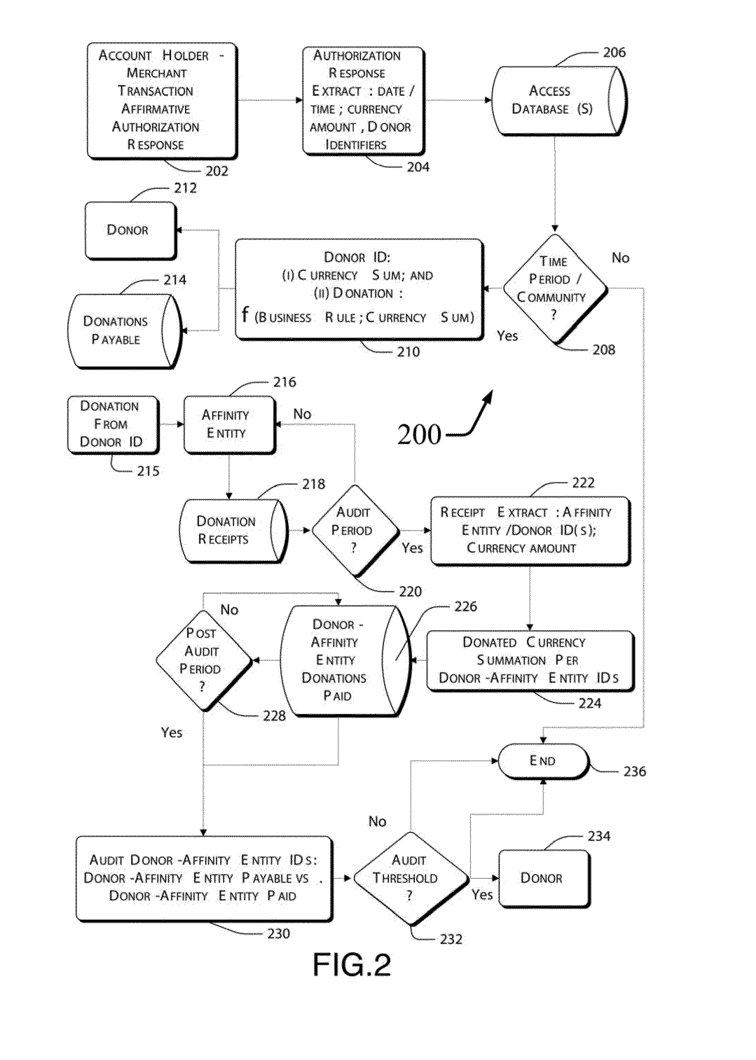

Referring to FIG. 2, a flowchart illustrates a Process 200 that can be performed by a system, such as a system including Web Service 100 in FIG. 1 and/or Donation Audit Web Service 314 seen in FIG. 3, for using local merchants' commitments to make charitable contributions as incentives to local residents to conduct transactions with local merchants. Prior to step 202 of Process 200, as discussed above with respect to FIG. 1, a registered local community resident conducts a transaction on an account issued to the resident at a brick and mortar store of a local community merchant. Prior to this transaction, as discussed above with respect to FIG. 1, the registered local community resident may receive one or more such offers 102, either passively and/or actively by request.

At step 202 of FIG. 2, information is received as derived from a positive authorization response originating from an issuer of an account, or its agent, upon which the transaction was conducted by the customer/account holder with the merchant who made offer 102 as describe above with respect to FIG. 1. Data from this information can be extracted at step 204 by a POS such as POS 106 seen in FIG. 1, including, by way of example and not by way of limitation, the date and time of the transaction, a total currency amount to be paid to the merchant at clearing and settlement on the customer's account, respective identifiers for the merchant and customer, etc.

Identifiers retrieved at steps 202-204 can be used to access one or more databases at step 206. The date and time for the transaction can be compared to ensure the non-expiration of the offer made by the merchant to the customer in a query at step 208. While an invalid offer determination ends Process 200 at step 236, Process 200 proceeds to step 210 when the offer is valid as determined at query 208.

At step 210, rules for calculating a the merchant's donation are made for one or more affinity entity recipients via retrieval of information using data acquired in steps 202-204. These calculations can include steps to access one or more databases as shown at reference numerals 212-214, including transmitting to and/or storing the calculated donations in one or more merchant donor databases 212 and/or in one or more merchant donations payable databases 214.

Subsequent to the acquired transaction on the resident's account as processed in steps 202-214 of Process 200, the local merchant makes the calculated donation to the local affinity entity as shown at step 215. The local affinity entity, as shown at step 216, sends notice of the donation's receipt for storage in one or more databases as shown at step 218.

After a predetermined audit time period as passed as determined by a query at step 220, an audit is conducted to insure compliance by each community merchant in its donation commitments to each of the one or more affinity entities or charities for which prior notice of such donations were provided to the merchant. This audit can include adding up all required donations for each local merchant to each affinity entity or charity as shown at step 222. The donation summation for each local merchant to each affinity entity or charity derived at step 224 is compared to information in one or more databases 226 to ascertain compliance of each merchant with its donation obligations. Stated otherwise, the local merchant has a certain amount of time after a predetermined audit period, as determined at step 228, by which to complete or make all of the merchant's donation obligations to all affinity entities.

Differences between donations paid and donations still payable by each local merchant are calculated at step 230, which differences are subjected to an audit threshold query at step 232. If a local merchant's donations paid is non-compliant with donations still payable, as may be determined by the audit threshold query at step 232, then Process 200 moves to step 234 to notify the local merchant, or its agent, accordingly of its deficiency. Otherwise, affirmative results at query 232 causes Process 200 to terminate at step 236 which may also include notice of compliance being transmitted to each such complaint local merchant, its customers, and/or each of the local affinity entities. Each such notice can be either by way of summary report, donations to respective affinity entities by the merchant, and variations thereof. Note also that progressive summaries of donations can be widely broadcast periodically incident to fundraising campaigns, capital development initiatives, and times of community need, thereby providing social motivation and incentives to an entire community of participating shoppers to help charities simply by purchasing from participating merchants.

In other implementations, Process 200 includes the exaction of data from information derived incident to a positive authorization response for an acquired transaction conducted on a resident's account, such as chronological information pertaining to the transaction including date and time, a currency amount of the transaction, and any other data desired to assist in a proper calculation of the merchant's obligatory donation to affinity entity 216. By way of example, an identifier for the merchant can be extracted, as well as an identifier for the local community resident as offered to the merchant by the same. The account number, by way of non-limiting example, can be a Primary Account Number (PAN) including a Bank Identifier Number (BIN) for a credit or debit card that is kept by the merchant in a ‘card-on-file’ database.

Note that, in various implementations, business rules can be set and used such that obligatory donations to Affinity Entity(ies) 216 can be made by one or more of the following participants in a payment processing system: the account holder, the account holder's issuer, the merchant, the merchant's acquirer, and the transaction handler. Via access to one or more databases at step 206, and by using the merchant and/or account holder identifiers extracted from the information derived from the positive authorization response, more information can be retrieved. Thereafter, database access can retrieve business rules used to calculate one or more donations that are to be made to the charities or affinity entities by one or more donors respectively corresponding to the account holder, the account holder's issuer, the merchant, the merchant's acquirer, and the transaction handler. Each such donation can be a function of the currency amount of the transaction and the retrieved business rule(s).

In some implementations, donations, per extracted donor IDentifier (ID), are made for those transactions that occur during a predetermined time-period and, optionally, within a predefined geographic location as determined by a query (not shown). If the result regarding a community, geography, or neighborhood query is affirmative, process 200 moves to step 210 where the donations that are to be made by the donor participants in the payment processing system are calculated as a function of the respective business rules. Otherwise, no donation is made and process 200 terminates at step 236. Stated otherwise, in such implementations, Process 200 is intended to obligate a local merchant to make a donation to a local affinity entity (e.g., a local charity) when a local resident conducts a transaction at the local merchant's brick and mortar store in the same community where the local resident resides. Note that the terms ‘local’, ‘resident’, ‘residential’, ‘community’, neighborhood, and the like, can be alternatively defined as described elsewhere herein.

As in other implementations described above, donations calculated at step 210 are communicated to the local merchant donor, or its agent, at step 212, and are stored in a donations payable database 214. Thereafter, donations 215 are received at affinity entities 216 at step 215 from donors identified by either respective donor IDs, which can be the identifier for the merchant or for other payment processing system participants. Donations received are stored in donation receipts database 218. Data from donations that are made by donors via communication to affinity entities 216 during an audit period, as determined at query 220, is extracted at step 222. The donation-related data that is extracted at step 222 can include the donor ID, and the currency amount of the donation. During the audit period, a sum of donations to each affinity entity 216 made by each local merchant donor for the audit period is calculated and stored in a donor-Affinity Entity donation paid database 226. After a predetermined time period, an audit period begins, as determined by query 228. During the audit time period, differences in donations paid are compared to donations payable for each donor at step 230. Differences exceeding a predetermined audit threshold, as determined by query 232, are communicated to the respective local merchant donors, or their respective agents, at step 234. Of course, the charitable audit functions, such as have been described above, can be performed by an agent of any donor and/or of a loyalty system organization charged with implementing all or portions of process 200. Such an auditing agent can be, by way of non-limiting example, a certified public accountancy agency, a non-government regulatory agency, a governmental agency, and the like.

As further discussed above with respect to various implementations, a donation mechanism can be set up such that the merchant-donor makes blind donations, either directly or indirectly, to a single donation disbursement entity who in turn disburses the donations to those affinity entities selected by the customers of the merchant-donor. This donation mechanism provides neither knowledge nor notice to merchant-donor as to the identities of its donation recipients, thereby avoiding circumstances that force a merchant, by virtue of its prior commitment, to donate to a local community affinity entity or charity whose role or purpose is inimical or otherwise repugnant to the merchant-donor. As such, the donation mechanism leaves the direction of the merchant's donation fully within the discretion of the customer, limited only, in some implementations, by the restriction that the customer can only select from among those affinity entities or charities that serve the local community that is in common to both the customer and the merchant-donor, while leaving the actual currency amount of the donation fully within the discretion of the merchant-donor.

Referring now to FIG. 3, an exemplary process 300 is depicted of a particular financial transaction system, such as may be described as an open loop system, in which an account holder (p) 308 conducts a financial transaction with a Merchant (m) 310. By way of example, the Account Holder (p) 308's financial transaction with the Merchant (m) 310 may have been incentivized by the Merchant (m) 310's agreement to make a donation to an Affinity Entity (k) 395 in the local community as defined by the Merchant (m) 310 through an ad incentive which, optionally, can be communicated to Account Holder (p) 308, whether requested or not.

In FIG. 3, by way of explanation for the nomenclature of reference numerals used and described in the specification, a lower case letter in parenthesis is intended to mean an integer variable having a value from 1 to the capital case of the lower case letter, which value can be large (i.e., approaching infinity). Thus ‘(b)’ is intended to mean that the integer ‘b’ can have a value from 1 to B, and ‘(c)’ is intended to mean that the integer ‘c’ can have a value from 1 to C, etc. As such, drawing elements 304-310 and 376-390, and 396 in FIG. 3 are illustrated with a block, but indicate one or more elements can be present. For example, Issuer (j) 304 is one of a possible plurality of issuers, where j may range from 1 to a large integer ‘J’.

Account Holder (p) 308 presents an electronic payment device (i.e.; a credit card) to a Merchant (m) 310 as tender for a financial transaction such as a purchase of goods and services. As part of the transaction, the Account Holder (p)'s 308 payment device can be a credit card, debit card, prepaid card, cellular telephone, Personal Digital Assistant (PDA), etc. Those of skill in the art will recognize that other financial transactions and instruments other than credit cards may also be used, including, but not limited to, a prepaid card, a gift card, a debit card, a token equivalent of an account as communicated via cellular telephony, near field communications, and the like. For purposes of illustration and explanation, however, reference will be made to a credit card.

The payment device can be manually keyed into a POS or can be read by a reader operated by the Merchant (m) 310, whereupon account information is read from the payment device and a request for authorization is transmitted to the Merchant (m) 310's Acquirer (i) 306. Each Acquirer (i) 306 is a financial organization that processes credit card transactions for businesses, for example merchants, and is licensed as a member of a Transaction Handler 302 such as a credit card association (i.e., Visa Inc., MasterCard, etc.) As such, each Acquirer (i) 306 establishes a financial relationship with one or more Merchants (n) 310.

The Acquirer (i) 306 transmits the account information to the Transaction Handler 302, who in turn routes the authorization request to the account holder's issuing bank, or Issuer (j) 304. The Issuer (j) 304 returns information via an authorization response to the Transaction Handler 302 who returns the information to the Merchant (m) 310 through the Acquirer (i) 306. The Merchant (m) 310, now knowing whether the Account Holder (p) 308's credit card account is valid and supports a sufficient credit balance, may complete the transaction and the Account holder (p) 308 in turn receives goods and/or services in exchange. Most credit card associations instruct merchants that, after receiving an affirmative authorization response, the detailed credit card account information obtained by a point of service terminal (e.g., such as via a magnetic stripe scanner) must be deleted.

To reconcile the financial transactions and provide for remuneration, information about the transaction is provided by the Merchant (m) 310 to Acquirer (i) 306, who in turn routes the transaction data to the Transaction Handler 302 who then provides the transaction data to the appropriate Issuer (j) 304. The Issuer (j) 304 then provides funding for the transaction to the Transaction Handler 302 through a settlement bank. The funds are then forwarded to the Merchant's (n) 310 Acquirer (i) 306 who in turn pays the Merchant (m) 310 for the transaction conducted at step 362 less a merchant discount, if applicable. The Issuer (j) 304 then bills the Account holder (p) 308, and the Account holder (p) 308 pays the Issuer 304 with possible interest or fees.

Also shown in FIG. 3 are one or more Affinity Entities (k) 396 and a Donation Audit Web Service 314 that implementations processes by which donations to the one or more Affinity Entities (k) 396 from various donors, for instance, any Issuer (j) 304, an Merchant (m) 310, any Acquirer (i) 306, and the Transaction Handler 302. Donation Audit Web Service 314 implementations processes for the auditing of donations to the one or more Affinity Entities (k) 396. The Donation Audit Web Service 314 has access to information resources within the following databases: Account Holder DBs 378; Merchant DBs 380; Transaction Databases 382; Geographic Databases 384; Affinity Entity Donations Payable 386; Affinity Entity Donations Paid 388; and Affinity Entity Database 390.

By way of example, and not by way of limitation, construction of local, geographic, residential or community associations between merchants and their customers can include factors such as geographic, political, demographics, local transportation modes, navigational algorithms for geopolitical regions, cartographic data, planned communities, population density, cultural divides, racial population constituencies, census statistics, socio-economic factors, and combinations thereof.

As shown in FIG. 3, Databases 378-790 can be connected by one or more private or public networks, virtual private networks, the Internet, or by other means known to those skilled in the art. Moreover, not every entity seen in FIG. 3 at reference numerals 308, 310, 396 and 394 must necessarily have real time, uninterrupted access to any or all of the Databases 378-390. Each such Database 378-390 can assign, read, write, and query permissions as appropriate to the various entities. For example, a Merchant (m) 310 may have read access to the one or more Transactions Databases 382.

Each Transactions Database (a) 382 can be designed to store some or all of the transaction data originating at the Merchants (n) 310 that use a payment device for each transaction conducted between an Account holder (p) 308 and the Merchant (m) 310. The transaction data can include information associated with the account of an Account holder (p) 308, date, time, and an identifier sufficient to determine a physical geographic location where the transaction took place, among other more specific information including the amount of the transaction. The database can be searched using account information, date and time (or within proximity thereof), or by any other field stored in the database.

The Transactions Database (a) 382 is also designed to store information about each Merchant (m) 310, where the information can include a unique identification of each Merchant (m) 310, an identifier for each point of sale device in use by the Merchant (m) 310, and a physical geographic location of each store of the Merchant (m) 310.

Also included in the Transactions Database (a) 382 is account information for payment devices associated with Account holder (p) 308, such as part or all of an account number, unique encryption key, account information, and account name of an account holder who is registered to participate in a system in which donations can be made to each Affinity Entity (k) 390 as per rules stored in Merchant Database (b) 380. After registering to participate in the donation system, an Account holder (p) 308 initiates a qualifying purchase transaction with a Merchant (m) 310 by presenting a payment device (not shown) to the Merchant (m) 310. The payment device is typically presented at the Point Of Service terminal (POS) at which data thereon is read. Certain transaction information is transmitted from the POS (e.g., card track data) in route to the Merchant's (n) 310 Acquirer (i) 306. The transaction information can include account information, account name, transaction balance, transaction time, transaction date, and transaction location. Sensitive information includes information such account number and account holder name that identify and associate a particular account with a particular account holder. This transaction information may be transmitted via a less secure communication medium. In addition, a transmission of transaction data may occur with weak or no encryption between two or more points from the point of origin, such as the point of sale device at the Merchant (m) 310, and the ultimate destination, such as the Acquirer (i) 306. These points can include, without limitation, from the reader at the POS, the POS at the Merchant (m) 310 and a network router or computer that is connected to a network but is housed and maintained by the Merchant (m) 310 and between the Merchant (m) 310 and the Acquirer (i) 306. The communication channel could be Ethernet, wireless internet, satellite, infrared transmission, or other known communication protocols. Some or all of the transmission may also be stored for record keeping, archival or data mining purposes with little or no encryption. For example, the Merchant (m) 310 may store transaction data, including certain account information in the Merchant's (n) 310 accounts on file database for reuse later.

During a transaction conducted by Merchant (m) 306 on an account issued by Issuer (j) 304 to Account Holder (p) 308, information relating to the qualifying purchase is retrieved from the POS at Merchant (m) 306. The transaction information is comprised of account information together with other information about the transaction itself: time, date, location, value, etc. Certain of the transaction information are considered sensitive information including, without limitation, account number, credit card verification number, and account name.

For the Account Holder (p) 308 to donate to each Affinity Entity (k) 396 as may have been previously specified, the Account Holder (p) 308's Issuer (j) 304 can pay the Affinity Entity (k) 386 and apply a debit in that currency amount on the Account Holder (p) 308's periodic revolving credit statement. The Account Holder (p) 308, upon receipt of the statement, can thereafter make a total payment to the Issuer (j) 304 of the currency amount of the donation that appears as a debit on the statement along with the other credit charges that also appear on the Account Holder (p) 308's statement.

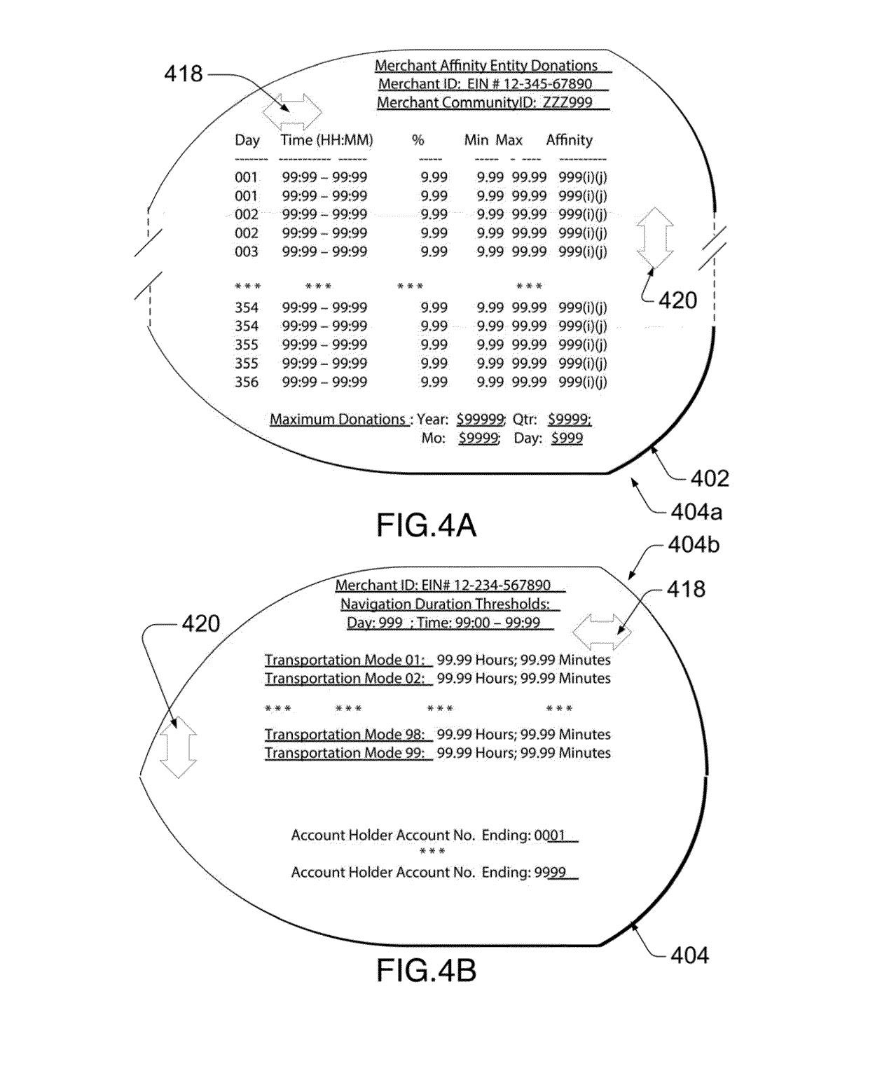

As discussed below with respect to FIGS. 4 a through 5b, both the Account Holder (p) 308 and the Merchant (m) 310 can change or disable a donation commitment at any time by accessing a server that serves web pages where respective user interfaces are provided. Thus, charitable donation commitments can be enabled or disabled using real time user interfaces. By way of example, and not by way of limitation, such servers can be hosted by the Donation Audit Web Service 314 seen in FIG. 3.

In various implementations, Donation Audit Web Service 314 seen in FIG. 3 receives information that confirms such a timely transaction between the customer and the merchant by way of receiving information derived from an authorization response for the transaction. As more fully described elsewhere herein with respect to FIG. 3, the information in the authorization response is typically generated by an Issuer (j) 304 who issued an account to the Account Holder (p) 308 (e.g., the customer or mobile device user) on which the timely transaction with the Merchant (m) 310 was conducted. A positive authorization response reflects the Issuer (j) 304's approval of the transaction on the account issued to Account Holder (p) 308. Stated otherwise, and as shown in FIG. 3 and discussion herein below, Donation Audit Web Service 314 receives the information derived from an authorization response from an acquired account payment processing system (i.e., see Ref. Num. 105 in FIG. 1), where each of the Issuer (j) 304, the Account Holder (p) 308, and the Merchant (m) 310 operate in the acquired account payment processing system.

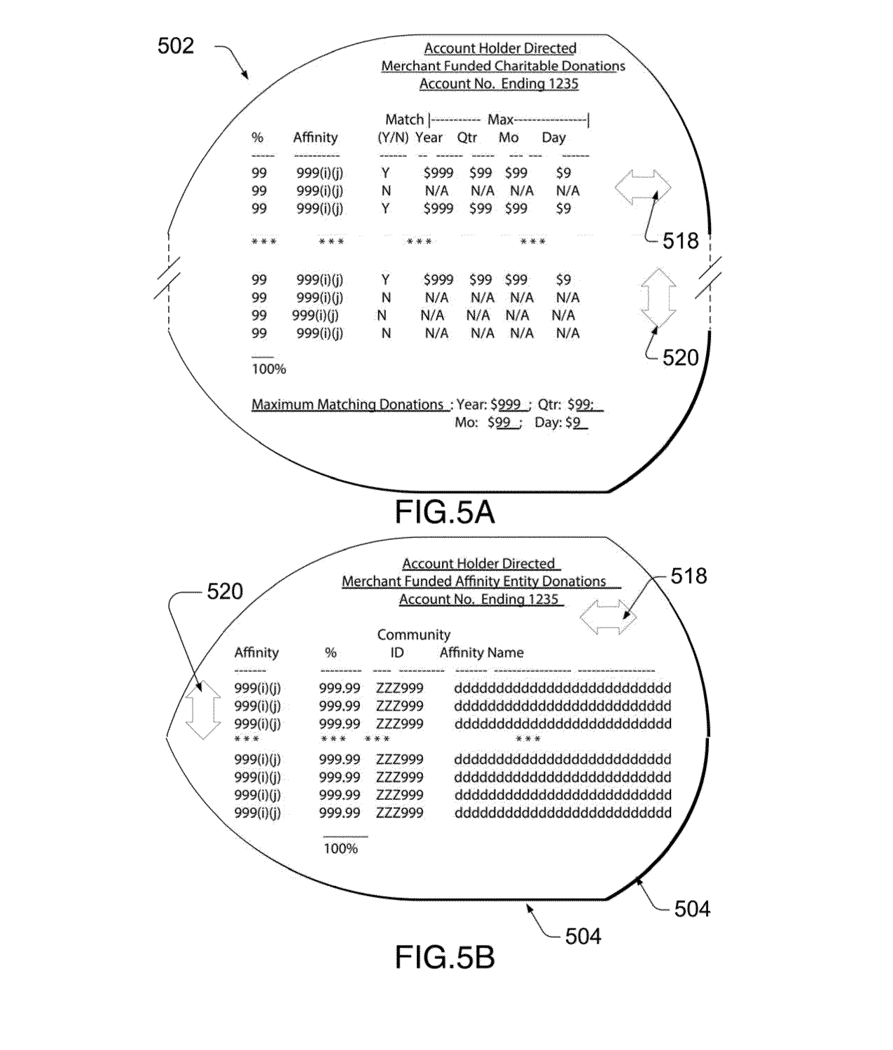

Once confirmation has been received by Donation Audit Web Service 314 that a timely transaction has taken place been the merchant who made the offer and the customer who selected and confirmed that offer, a calculation is made of an amount of a donation that is to be made by the merchant-offeror according to terms of the offer. By way of example, the terms of the offer to make the donation to the community affinity entity or charity 396 may have been previously input for storage in Merchant DBs 380 by way of the merchant's user interface provided by an application executing on a computing device, such as in conjunction with a screen shots 402-404 seen in FIGS. 4a-4b as described herein below. To give notice of the donation obligation that has arisen, the calculated donation can be sent in one or more transmissions from Donation Audit Web Service 314 to one or more logical addresses such as: (i) the Merchant (m) 310; (ii) the Affinity Entity 396; (iii) the Customer or Account Holder (p) 308—or to respective agents thereof. Optionally, information that identifies the Affinity Entity 396; and/or (iii) the Account Holder (p) 308 can be included in any such transmission.

Where the Affinity Entity 306 to which the Merchant (m) 310 is obligated by the timely transaction to make a donation is specified by the Account Holder (p) 308 (e.g., such as by use of a user interface having a screen shots 502-504 seen in FIGS. 5a-5b, respectively), the identity of the Affinity Entity 396 need not be communicated to the Merchant (m) 310. Rather, the Merchant (m) 310 can make a blind donation of the calculated amount to a third party for distribution to the Affinity Entity 396 in the Account Holder (p) 308's residential community. By such blind, albeit obligatory, merchant donations, conflicts and disagreements between Account Holder (p) 308 and Merchant (m) 310 as to right and proper objects of charity or affinity to the community can be avoided. As such, the Account Holder (p) 308 will transaction with community Merchants 310 by way of incentives from the community Merchants 310 that they will donate to the Account Holder (p) 308's favorite charity (e.g., Affinity Entity 396), though the charity may not be the Merchant (m) 310's favorite charity, or even a desirable charity, in that community. Nevertheless, the Merchant (m) 310 has received the benefit of customers' foot traffic inside the merchant's local brick and mortar store, as well as the benefit of transactions with some of those customer who enter the merchant's brick and mortar store, where each such benefit is realized by the merchant's offer to make a donation to the customer's favorite charity(ies) if a timely transaction occurs subsequent to the merchant's offer.

Referring now to FIGS. 4a-4b, screen shots 402-404 feature input capture and rendered display fields by which a Merchant (m) 310, or agent thereof, can input terms and conditions under which the Merchant (m) 310 is willing to become obligated to make a donation to an Affinity Entity (k) 396. Each row in screen shot 402-404 represent all or a portion of the twenty-four (24) hour day of the 356 calendar days of one (1) year. Columns in each row of the table seen in screen shot 402 are, from left to right, as follows: 1^{st}: the numerical calendar day of the year; 2^{nd}-3^{rd}: the hyphenated starting and ending of a time period within the calendar day; 4^{th}: a percentage of a currency amount of any one (1) transaction that the Merchant (m) 310 will commit to make to an Affinity Entity (k) 396; 5^{th}: the minimum currency amount of the transaction before the commitment by the Merchant (m) 310 to make the donation will arise; 6^{th}: the maximum amount of donation that the Merchant (m) 310 is willing to make for any one (1) transaction; and 7^{th}: an identifier for the Affinity Entity (k) 396 to whom the Merchant (m) 310 is to make the donation as described in the row. Note that, in some implementations where the customer picks the affinity entity, then the seventh column may not have data entered. In other implementations, the seventh column is a constant affinity entity that does not change, for example, where the affinity entity is not changeable (e.g., The United Way, the Red Cross, etc.) The bottom of screen shot 402 allows specification inputs for the Merchant (m) 510 as to its maximum donation across all Affinity Entities 396 (k) for any one day, month, quarter of a year, or year.

By way of example, and not by way of limitation, the data input by the Merchant (m) 310, or agent thereof, for display on screen shot 402 can obligate a donation to be made to an affinity entity that is higher at some days and times of the calendar year, and lower at other days and times of the calendar year. As such, it may be advantageous for the Merchant (m) 310 to provide proportional incentives by way of a higher donation incentive for typical slow business time-period of different calendar days and a lower donation incentive for typically busier business time-period of different calendar days.

Much of a community resident's spending occurs near the physical address of the resident's home. As such, it may be economically desirable for a merchant to provide its donation incentive only to those residents whose physical address is close enough to be regularly incentive by the merchant's donation offer, while not offering this incentive to others who would be unlikely, due to physical separation, to regularly shop at the merchant's physical location. Accordingly, and depending upon factors such as the demographics, population density, affluence, etc. of the physical location of the merchant, the merchant may input different navigation ranges for different likely-to-be-frequent shoppers according to any of the transportation modes that these potential-frequent shoppers are likely to take should these shoppers know and understand the merchant's donation incentive offer that is being made to them if they conduct a transaction with the merchant. Accordingly, the merchant may input at screen shot 404 any of various different travel methods (e.g., walking, automobile, bicycle, mass transit, etc.) and navigation time ranges.

Referring now to FIG. 4b, screen shot 404 allows a merchant, or its agent, to input one more minimum and maximum navigation times for different times on different days of the year. Each input navigation time range is used to determine whether or not the merchant will be obligated to make a donation to an affinity entity or charity. In practice, information derived from an affirmative authorization response for a transaction between the merchant and an account holder is obtained. This information will contain sufficient data that can be further used to retrieve and/or determine physical address information for the merchant and the account holder. Once physical address information for the merchant and the account holder customer are known, these physical addresses are used with a navigation time algorithm to determine the navigation time from the physical address of the account to the physical address of the merchant. If the determined navigation time is within the input minimum and maximum navigation time for one or more transportation nodes seen in the middle of screen shot 404 in FIG. 4b, and the date and the date and time of the transaction are within a time period and day as provided by the merchant's input as seen at the top of screen shot 404, then the merchant will be obligated to make a donation to an affinity entity or charity. Otherwise, the merchant is not obligated to make a donation to an affinity entity or charity.

The one or more different transportation modes seen in screen shot 404 of FIG. 4b each show minimum and maximum navigation times for different transportation modes. One such transportation mode can be by automobile, another by walking, and other by mass transit, another by a specific combination of different transportation modes (e.g., walk, subway, bus, and walk), etc.

Any of various navigation algorithms, both known and yet to be developed, can be used to determine whether the time, using one or more travel methods, is within the merchant's input navigation time range. The result of the algorithm's determination will ascertain whether or not the merchant and its customer share the same local community or ‘neighborhood’, and the merchant will accordingly be obligated to make donation when the customer buys something from the merchant. By way of example, the merchant and its customer might be determined to be within the same local community if the automobile drive time, as determined from one or more databases of contemporary cartographic road system information, to navigate between the merchant's brick and mortar store and the customer's residence is less than a predetermined time threshold (e.g., 17 minutes). The navigation algorithm used with the input from screen shot 404 and the respective physical addresses of merchant and account holder can be varied.

As stated above, the majority share of a community resident's annual spend, at least for some communities, tends to stay in their local community, a merchant in that community would like to incentivize residents in that community to conduct transactions with the merchant. As such, the merchant residing in a heavy-local spending community can choose to make an offer to any such community resident that a donation will be made to one or more affinity entities or charities that are designated by the community resident. The merchant's donation, however, can be made conditional. One such condition can be that the community resident resides in the community where the transaction is conducted with the merchant—where the community residence criteria are made upon a derivation of a specific navigation algorithm. A commercial reason behind the merchant's donation incentive is to attract customers who are likely to be repeat customers who will frequently shop at the merchant's store. Although somewhat dependent upon the type of goods and services provided by the merchant, and the location where the merchant is physically located, the type of customer that is most likely to be a repeat, frequent customer might be determined to be one who lives or works relatively close to the merchant's store. As such, screen shots seen in FIGS. 4a-4b provide input fields to receive incentives directed towards likely frequent shoppers, while disallowing donation incentive to customer who will be unlikely to travel to the merchant's store frequently due to distance, difficulty of the commute, etc.

In some implementations, the obligation for the merchant to donate can be tested in a variety of ways. One test for the customer's residence can be made by calculating the duration of a trip to navigate from a geographic location associated with community resident to a geographic location associated with the merchant. This calculation can be made by using one of more navigation time estimation algorithms. Stated otherwise, the duration of a trip to navigate from a geographic location associated with an account holder to a geographic location associated with the merchant can be calculated by using one of more navigation time estimation algorithms. By way of example, and not by way of limitation, any of the following algorithms, either alone or in combination, can be used when calculating a navigation time between places respectively associated with customer and merchant: (i) Depth-First-Search (DFS); (ii) backtracking search; (iii) Dijkstra's algorithm; (iv) Krushkal's algorithm; (v) Prim's algorithm, (a.k.a. DJP algorithm; (vi) the Jarnik algorithm or the Prim-Jarnik algorithm; (vii) Reverse-Delete algorithm; (viii) Bor [symbol] vka's algorithm; (ix) a navigation algorithm now conceived; (x) a navigation algorithm both conceived and reduced to practice; and/or (xi) a navigation algorithm that is developed in the future.

Another way to calculate navigation time between places respectively associated with customer and merchant is to outsource calculations to a public or private web service by transmitting the respective geographic place identifiers to an online navigation service for calculation of navigation time and receive by the navigation time estimate. By way of example, the pair of places can be sent to an online service for subsequent return of a navigation time estimate as are provided by a Google® maps service, a Bing® maps service, a Garmin® maps service, a Delorme maps service, a TomTom® maps service, a Mapquest® maps service. The navigation time estimate calculated, or received back from a web mapping service, can be a time for one or more transportation modes, including walking, automobile or taxi, bicycling, mass transit, or a combination thereof.

As shown in FIGS. 4a-4b, a merchant can designate, if each of several different time periods during each calendar day, the navigation time under which the merchant will make a donation to one or more charities designated by a customer who transacts with the merchant, as well as the corresponding percentage of the transaction amount that the merchant will donate. As such, a merchant can input data such that a greater or lesser donation is made as depends up the time, the day, and the navigation time, by any of several different modes of transportation, between locations respectively associated with the merchant and the customer who transacts with the merchant.

In the case of a geographic area having a high-density population (e.g., a city), a merchant may input small navigation times because local shoppers live close to the merchant's location. As such, the merchant is thereby committing to donate only those charities designed by customers who live close to the merchant—such as in ‘walking distance’. Alternatively, in rural and sparsely populated areas, the merchant may input larger navigation times because local shoppers are likely to drive in an automobile as the most reasonable transportation mode to arrive at the merchant's store. As such, the merchant is thereby committing to donate only those charities designed by customers who live close enough to drive a reasonable distance to the merchant's store.

A merchant may choose not to make a donation to any customer who is identified with a residence or location that is too far from the merchant's location to represent potential frequent repeat business. As such, input by the merchant would be unfavorable towards any donation to the designated charities of a shopper who is unlikely to regularly shop at the merchant's business.

The navigation time input by the merchant might preferably be dependent upon the types of goods and services provided by the merchant. Merchant offering only commodity items, such as grocery stores, would be like to input shorter navigation times that merchants typically providing rare and hard-to-find items for which customers are more likely to be willing to make longer commutes in order to make purchases.

FIG. 4b allows a merchant to input different navigation time thresholds for any of several different kinds of transportation modes, such as walking, driving, mass transit, and there combinations. For instance, if at least one of the navigation times from a customer's residence to the merchant's store for different transportation modes is less that an input threshold, then the merchant will make a donation the customer's identified charities after the customer's transaction with the merchant has been authorized.

FIG. 4b shows a portion of screen shot 404 where the merchant can input an identifier for one or more customers (e.g., an account or member number), where the merchant will donate to each such customer's identified charities. Note that, in this implementation and variations thereof, the merchant's obligation to donate is fixed regardless of any navigation time that may apply for the customer to travel from the customer's resident to the merchant's store, although other criteria may apply, such as the date and time parameter seen in FIG. 4a which must be satisfied by the date and time of the transaction. Alternatively, input can be made by the merchant per screen shot 404 in FIG. 4b such the merchant will donate to each identified customer's charities regardless of navigation time or time of day, though within the limits of donation see a the bottom of screen shot 402.

The local community of each of the merchant and its customer can be determined in still other ways in other implementations, where the merchant's obligation to donate will not be fixed unless the respective physical addresses of merchant and customer are in the same community or neighborhood according to a predetermined algorithm. Any such local community determination can be made in any of several different methods, or combinations thereof, according to the merchant's preference as to what algorithm is mostly likely to attract the most favorable foot traffic to the merchant's brick and mortar store. One such method is a political or legal division, that is, the merchant's place of business is determined to be in the same political or legal division as that of its customer's residence, such as the same province, state, county, prefecture, city, city-state, borough, etc. Another such comparison can be whether the merchant's place of business has a governmentally issued postal code that is the same or within a predetermined proximity as that of its customer's residence. Yet another such comparison can be whether the merchant's place of business and its customer's residence are physically proximate within a predetermined factor by any of a variety of measures or combinations thereof. For example, latitude and longitude coordinates might be known for both the merchant's place of business and the residence of its customer. These coordinates can be used to determine whether the linear distance there between is within a predetermined distance to ascertain whether or not the merchant and its customer share the same local community.

A further alternative implementation will use an algorithm that uses the population density of the merchant's brick and mortar store and the customer's residence, as well as real time transportation data such as traffic conditions, bus and subway availabilities, etc. If the population density exceeds a predetermined density, then the merchant and its customer might be determined to be within the same local community if the time to walk, bicycle or take public transportation between the merchant's brick and mortar store and the customer's residence, as determined from one or more databases of contemporary topographic, mass transit, and/or pedestrian cartographic system information, is less than a predetermined time threshold (e.g., 55 minutes).

Still another such comparison can be whether the merchant's place of business and its customer's residence are proximate or the same according to voting, electoral, or political districts. The district use can be determined by an official method, an unofficial method, or a combination of methods. By way of example, measurements known within the political gerrymander sciences can be used, including but not limited to a minimum district to convex polygon ratio, shortest split line algorithm, minimum isoperimetric quotient, etc.

The local community corresponding to that of the merchant and its customer, and separations there between (if any), can be determined from any combination of linear distance, mode-specific navigational transportation travel time, political separation, postal designation, and/or hybrid algorithm that takes into considers geographic barrier features such as rivers, cliffs, and highways, cultural features such as boundaries of identified people groups (e.g., tribes, first nation people, etc.), land ownership such as subdivisions, housing projects, cooperatives, planned communities, military installations, governmental owned and leased properties, etc. Given the foregoing, an algorithm might find that the merchant and its customer are members of the same community, not members of the same community, or are both members of more than one of the same communities as determined by the algorithm.

Similar or different algorithms that are used to determine the respective local community of the merchant and its customer can also be used to determine the local community of an affinity entity such as that shown on FIG. 1 at reference numeral 122, or as that shown as an Affinity Entity (k) 396 in FIG. 3, as discussed herein below. These determinations can be performed when a donation term is conditioned upon the location, neighborhood or community of the Affinity Entity (k) 396.

Data input in the user interface depicted by screen shots 402-404 can be stored in one or more of the Merchant DBs 380 or other location logically accessible, via one or more networks or otherwise, to Donation Audit Web Service 394. These data can also be automatically pre-loaded for Merchant (m) 310 via an automatic initiating service (e.g., an data auto-boarding or auto-populating operation) that allows the Merchant (m) 310 to be automatically entered as a participant in a local community charitable donation program that incentivizes increased local resident foot traffic to each store location of the Merchant (m) 310 in the local community. Note that auto-boarding allows small and medium sized merchants to enter such a program with little or no effort by using default data in auto-populating information to be used for the merchant's participation in the program.

As seen in FIGS. 4a-4b, each offer input by the merchant to donate to a local affinity entity is not be specific to a particular good or service that the merchant will provide to its customer in a transaction. Rather, the offer is specific to the entire transaction between the merchant and its customer. By way of example as to this type of offer specificity, the offer may obligate the merchant to make a donation of a certain percentage of the entire currency amount of transaction, or the offer may obligate the merchant to make a donation only if the transaction is conducted at a certain time of day or on a particular day of the week, or a combination of the foregoing. Although some terms of the offer may differ from some terms of the transaction, nevertheless, the merchant's offer to make a donation to a local affinity entity (e.g., a local charity) has the goal of fundamentally providing an incentive that causes, at least in part, the local community resident to navigate to the local merchant's brick and mortar store as new foot traffic, and ultimately to conduct a transaction that brings revenue to the brick and mortar store of the local merchant.

By way of exemplary implementation of data input to a field in screen shot 402, a received identifier might identify a specific Affinity Entity (k) 396 that is located in, and provide goods and services to, the borough of Greenwich Village at the southern portion of the geographical island of Manhattan in the city of New York of the State of New York, in the USA. By way of example, and not by way of limitation, an Affinity Entity Code having the character string “105(064) (q2e)”, which would be input in the 7^{th} column of screen shot 402, could have an interpretation where ‘105’ represents the United States of America, the index ‘064’ represents the state of New York, “q” represents the City of New York, “2” represents the combined boroughs of Manhattan, and “e” represents the borough of Greenwich Village at the southern portion of the geographical island of Manhattan in the city of New York of the State of New York. The name of the specific Affinity Entity (k) 396 represented the character string “(105) (064) (q2e)” can be the Washington Square Food Bank, which may be located in, and provide goods and services to, the borough of Greenwich Village at the southern portion of the geographical island of Manhattan in the city of New York of the State of New York, in the USA.

Note that the merchant can use screen shot 402 to specify multiple community IDs each representing a geographic location where the Account Holder (p) 308 either has a residence or operates a business in the geographic location. Also note that, for each such community ID specified by the merchant, the second column of the rows of screen shot 404 in FIG. 4b will preferably add up to 100%, thereby provide a percentage the donation made by the Merchant (m) 310 with whom the Account Holder (p) 308 conducting a transaction.

For screen shots 402-404, input and selection of data for each Affinity Entity can be via a typical user experience including but not limited to keyboard data entry, pull down menus, pictograph optical scanning with a cellular telephony device as read from print or electronic media rendering, etc. Horizontal 418 and vertical 420 panning can be user activated to move that portion of the display being rendered horizontally and vertically, respectively.

Referring now to FIGS. 5a-5b, a screen shot 502 features input and displays fields by which an Account Holder (p) 308, or agent thereof, can direct a third party donor, such as a Merchant (n) 310 with whom the Account Holder (p) 308 is conducting a transaction, to become legally bound to make a donation to an Affinity Entity (k) 390. Alternatively, or in combination, these data fields can be auto-populated in an auto-boarding process that facilitates immediate participation by Account Holder (p) 308 in the above described merchant donation program. Each row in screen shot 502 represents a different affinity entity. Other donors so directed by the Account Holder (p) 308's data entry can optionally include each issuer (j) 304, the transaction handler 302, and the acquirer (i) 306. The Affinity Entity (k) 490 is expressed in each row by an integer indexed in both T and T variables. By way of example, such an indexing system might identify a specific Affinity Entity (k) 390 by the code 105(064) (q2e), where ‘105’ represents the international charitable organization “United Way”, the index ‘064’ represents that organization's affiliated charity within the United States of America, and the index ‘q2e’ represents the borough of Greenwich Village at the southern portion of the geographical island of Manhattan in the city of New York of the State of New York.

Other columns in each row of the table seen in screen shot 502 are, from left to right, as follows: 1^{st}: the percentage of the donor's donation that the account holder directs to be donated to the charity identified in the 2^{nd} column; 3^{rd}: a yes or no indication whether the account holder will match the donor's donation to that charity; and the 4^{th} through the 7^{th} columns: the maximum currency amounts that the Account Holder will commit to give to the identified charity for the current year, quarter, month and day, respectively. The bottom of screen shot 502 allows a customer to specify the maximum total of all matching contributions to all affinity entities of charities that the Account Holder (p) 308 is willing to commit for the current year, quarter, month and day, respectively.

Screen shot 504 in FIG. 5b shows a plurality of rows. Each row includes an affinity entity, the percentage of any donation that the account holder requires to be made to that affinity entity, an identifier for a community associated with the affinity entity, and a description or name of the affinity entity. Note that the sum of the second column of the row must equal one hundred percent (100%).

For the Account Holder (p) 308 to make the matching donations to the Affinity Entities that are specified in screen shot 502 of FIG. 5a, the Account Holder (p) 308's issuer (j) 304 can pay the Affinity Entity (e) 388 and place a debit in that currency amount on the Account Holder (p) 308's periodic revolving credit statement. The Account Holder (p) 308, upon receipt of the statement, can thereafter make a total payment to the issuer (j) 304 of the currency amount of the donation that appears as a debit on the statement along with the other credit charges that also appear on the Account Holder (p) 308's statement.

For screen shots 402-504, input and selection of data for each charity can be via a typical user experience including but not limited to keyboard data entry, pull down menus, pictograph optical scanning with a cellular telephony device as read from print or electronic media rendering, etc. Horizontal 418, 518 and vertical 420, 520 panning icons can be user activated to move the rendered display, respectively, on screen shots 402-504.

The Account Holder (p) 308 and the Merchant (m) 310 can change or disable a donation commitment at any time by accessing a server that serves web pages rendering screen shots 402-504. Thus, charitable donation commitments can be easily and instantly, and both enabled or disabled, using the real time user interface. By way of example, and not by way of limitation, one or more of such servers can be hosted by the Donation Audit Web Service 314 seen in FIG. 3.

In some implementations, the fields provided by screen shot 502 allow the customer to specify one or more affinity entities in their local community to which donations are to be made by merchants with whom the customer conducts transactions. In such implementations, each merchant is given notice of its total periodic donations. Such notice, however, can optionally be given without providing the merchant with any notice or knowledge as to the specific identity of those affinity entities that are to be the recipients of its donations. The donation mechanism can be set up such that the merchant makes blind donations, either directly or indirectly, to affinity entities in the local community of both the merchant and its customer who selects those local community affinity entities. Accordingly, the donation mechanism can leave direction of merchant's donations fully within the discretion of the merchant's customers, limited only by the restriction that the customer can only select from among those affinity entities that serve the local community that is in common to both the merchant and the customer, while leaving the actual amount of the merchant's donation fully within the discretion of the merchant as shown with respect to FIGS. 4a-4b.

Optionally, a further limitation on those local community affinity entities that can be selected by the customer can include an algorithm that accesses a rating, and/or that derives a rating, for an affinity entity. The algorithm can use one or more ratings given by one or more charity rating organizations, where the algorithm's result is used to determine whether or not the affinity entity is eligible for participation in the implementation as a registered affinity entity that is selectable by local community customers. The ratings can be retrieved by Donation Audit Web Service 314 by its access to one or more databases where such ratings are input and maintained. Example of charity rating organizations which provide one or more ratings that could be used for various disclosed implementations include Guide Star, Charity Navigator, Give Well, Evangelical Council for Financial Accountability (ECFA), the Better Business Bureau Wise Giving Alliance Standards for Charity Accountability of the Council of Better Business Bureaus, Inc., and the like that now exist or may exist in the further. Moreover, the reader will understand that current or future developed algorithms for assessing local community affinity entities can be used to determine whether or not affinity entities are eligible for participation in the disclosed implementations as registered affinity entities that are selectable by local community customers and/or local merchants.

Still another implementation relates to an open loop cashless payment system that incents an account holder to transact with a merchant who agrees to make an auditable donation to an affinity entity or charity when the transaction is conducted on an account issued to the account holder. The account holder can direct the donation to a specific charity within a predetermined geographically determined community where the transaction was physically conducted. The account holder can register an obligation to make a donation matching that of the merchant, where the account holder's donation is initially paid by the account's issuer for reimbursement by the account holder to the issuer after the account holder receives their account statement. The merchant's acquirer, the issuer, and a transaction handler for the issuer and acquirer can also make donations as directed by the account holder. Various donor and account holder directed business rules limit the total currency amount of donations over specific calendar periods.

Referring again now to FIG. 3, further illustrations are seen of a telecommunications network that may make use of any suitable telecommunications network and may involve different hardware, different software and/or different protocols then those discussed below. FIG. 3 is a global telecommunications network that supports purchase and cash transactions using any bankcard, travel and entertainment cards, and other private label and proprietary cards. The network also supports ATM transactions for other networks, transactions using paper checks, transactions using smart cards and transactions using other financial instruments. These transactions are processed through the network's authorization, clearing and settlement services. Authorization occurs when an issuer approves or declines a sales transaction before a purchase is finalized or cash is dispersed. Clearing occurs when a transaction is delivered from an acquirer to an issuer for posting to the customer's account. Settlement is the process of calculating and determining the net financial position of each member for all transactions that are cleared. The actual exchange of funds is a separate process.

Transactions can be authorized, cleared and settled as either a dual message or a single message transaction. A dual message transaction is sent twice—the first time with only information needed for an authorization decision, an again later with additional information for clearing and settlement. A single message transaction is sent once for authorization and contains clearing and settlement information as well. Typically, authorization, clearing and settlement all occur on-line.

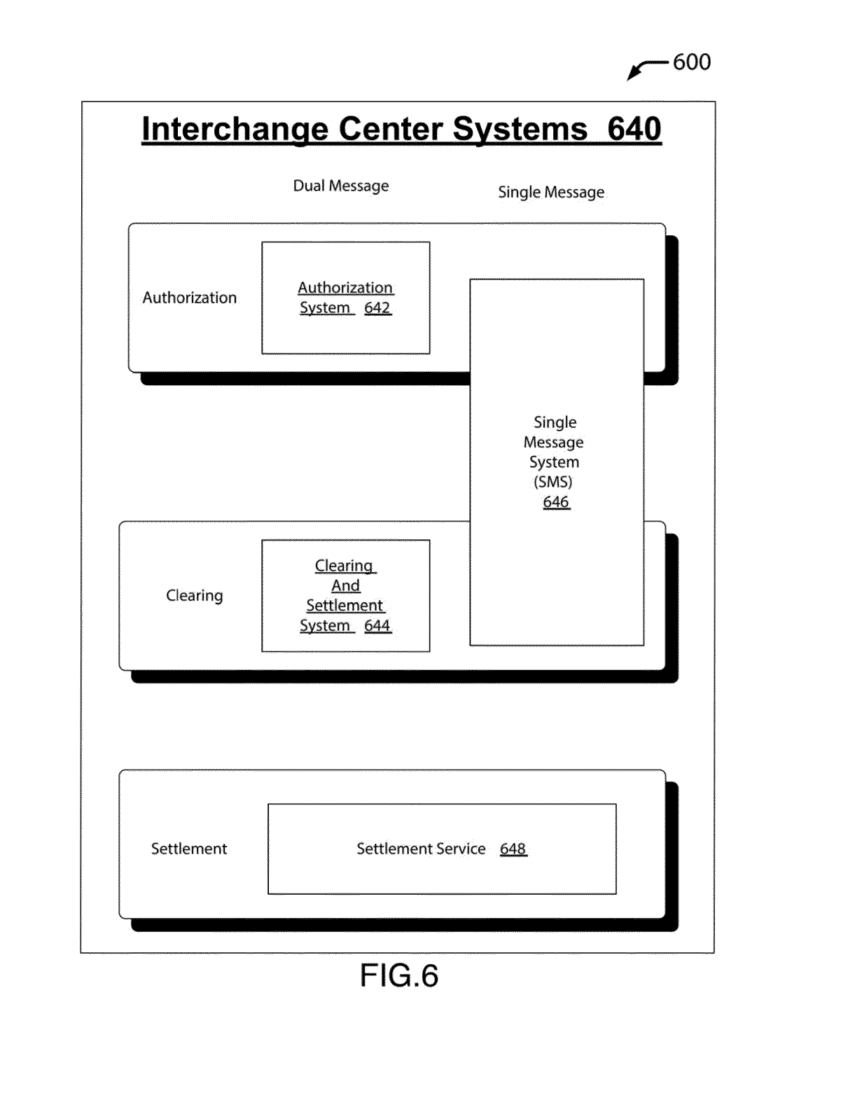

Referring now to FIGS. 1, 3, and 6-7, FIG. 3 includes access points 330, 332 between Transaction Handler 302 and each Acquirer (i) 306 and Issuer (j) 304. Other entities such as drawee banks and third party authorizing agents may also connect to the financial; network through an access point (not shown). An interchange center has systems, such as those seen at reference numeral 640 see in FIG. 6, so as to be a data processing center that may be located anywhere in the world. Each interchange center houses the computer system that performs the network transaction processing. The interchange center serves as the control point for the telecommunication facilities of the network, which comprises high-speed leased lines or satellite connections, for instance as may be based on IBM SNA protocol. Preferably, the communication lines that connect an interchange center (Transaction Handler 302) to remote entities use dedicated high-bandwidth telephone circuits or satellite connections, for instance as may be based on the IBM SNA-LU0 communication protocol. Messages are sent over these lines using any suitable implementation of the ISO 8583 standard.

Access points 330, 332 are typically made up of small computer systems located at a processing center that interfaces between the center's host computer and the interchange center system 640. The access point facilitates the transmission of messages and files between the host and the interchange center supporting the authorization, clearing and settlement of transaction. Telecommunication links between the Acquirer (i) 396 and its access point 332, and between the access point 330 and Issuer (j) 304 are typically local links within a center and use a proprietary message format as preferred by the center.

A data processing center (such as is located within an acquirer, issuer, or other entity) houses processing systems that support merchant and business locations and maintains customer data and billing systems. Preferably, each processing center is linked to one or two interchange centers. Processors are connected to the closest interchange, and if the network experiences interruptions, the network automatically routes transactions to a secondary interchange center. Each interchange center is also linked to all of the other interchange centers. This linking enables processing centers to communicate with each other through one or more interchange centers. In addition, processing centers can access the networks of other programs through the interchange center. Further, the network ensures that all links have multiple backups. The connection from one point of the network to another is not usually a fixed link; instead, the interchange center chooses the best possible path at the time of any given transmission. Rerouting around any faulty link occurs automatically.

FIG. 6 illustrates Interchange Center systems 640 housed within an interchange center to provide on-line and off-line transaction processing. For dual message transaction, authorization system 642 provides authorization. Authorization system 642 supports on-line and off-line functions, and its file includes internal systems tables, a customer database and a merchant central file. The on-line functions of system 642 support dual message authorization processing. This processing involves routing, account holder and card verification and stand-in processing, and other functions such as file maintenance. Reporting includes authorization reports, exception file and advice file reports, POS reports and billing reports. A bridge from system 642 to a Single Message System (SMS) 646 makes it possible for issuers and acquirers to use system 642 to communicate with other issuers and acquirers using system 646 and access the SMS gateways to outside networks.

Clearing and settlement system 644 clears and settles previously authorized dual message transactions. System 644 collects financial and non-financial information and distributes reports between members. It also calculates fees, charges and settlement totals and produces reports to help with reconciliation. A bridge forms an interchange between system 644 processing centers and system 648 processing centers.

Single message system 646 processes full financial transactions and can also process dual message authorization and clearing transactions, as well as communicate with system 642 using a bridge and accesses outside networks as required. System 646 processes cashless issued account-based acquired transactions, for instance Visa, Plus, Interlink. Maestro, Cirrus, and others. By way of example, SMS files comprise internal system tables that control system access and processing, and an account holder database, which contains files of account holder data used for Personal IDentifier (PIN) verification and stand-in processing authorization. System 646 has on-line functions that perform real-time account holder transaction processing and exception processing for authorization as well as full financial transactions. System 646 also accumulates reconciliation and settlement totals. System 646 also has off-line functions that process settlement and funds transfer requests and provide settlement and activities reporting. Settlement service 648 consolidates the settlement functions of system 644 and 646 for cashless issued account-based acquired transactions into a single service for all products and services. Clearing continues to be performed separately by system 644 and system 646.

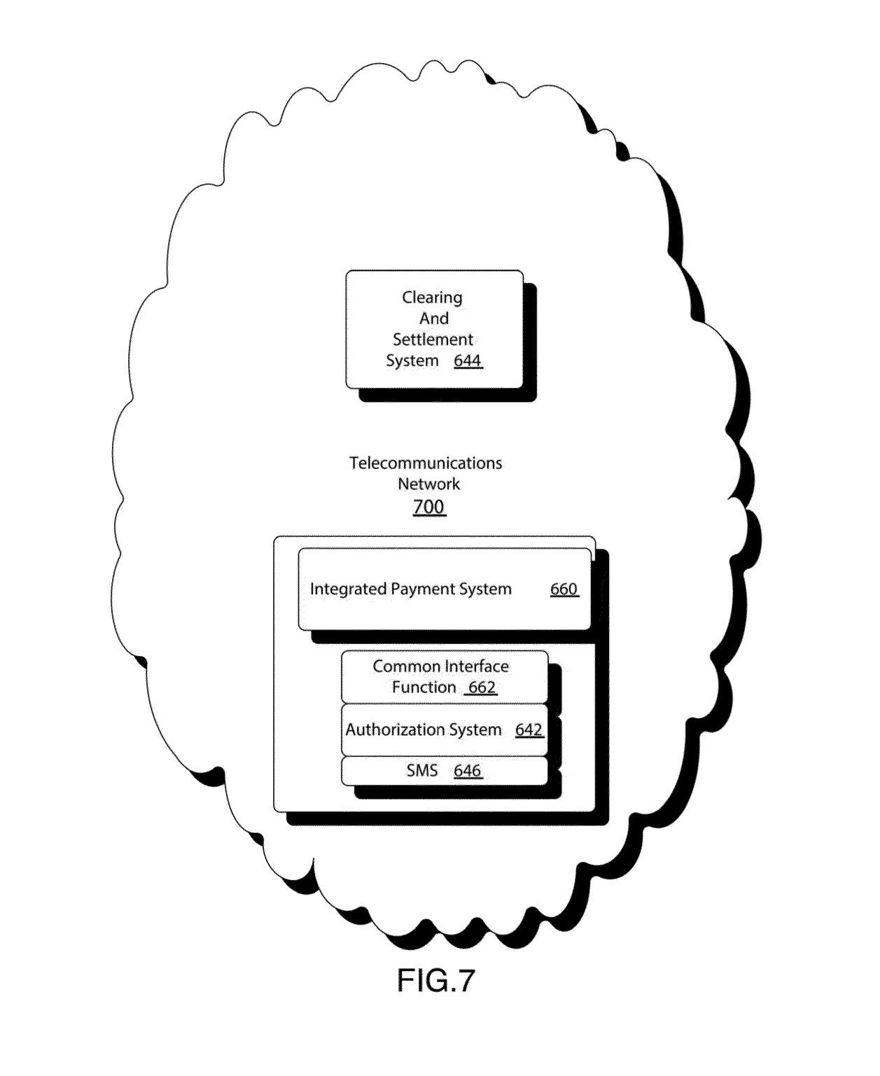

FIG. 7 illustrates another view of components of FIG. 6 in a telecommunications network 700. Integrated payment system 760 is the primary system for processing all on-line authorization and financial request transactions. System 760 reports both dual message and single message processing. In both cases, settlement occurs separately. The three main software components are the common interface function 762, authorization system 742 and single message system 746.

Common interface function 762 determines the processing required for each message received at an interchange center. It chooses the appropriate routing, based on the source of the message (system 742, 744 or 746), the type of processing request and the processing network. This component performs initial message editing, and, when necessary, parses the message and ensures that the content complies with basic message construction rules. Common interface function 762 routes messages to their system 742 or system 746 destinations.

Referring again now to FIGS. 1, 3, and 6-7, further illustrations are seen of a telecommunications network that may make use of any suitable telecommunications network and may involve different hardware, different software and/or different protocols then those discussed below. FIGS. 1, 3, and 6-7 can include a global telecommunications network that supports purchase and cash transactions using any bankcard, travel and entertainment cards, and other private label and proprietary cards. The network also supports ATM transactions for other networks, transactions using paper checks, transactions using smart cards and transactions using other financial instruments. These transactions are processed through the network's authorization, clearing and settlement services. Authorization occurs when an issuer approves or declines a sales transaction before a purchase is finalized or cash is dispersed. Clearing occurs when a transaction is delivered from an acquirer to an issuer for posting to the customer's account. Settlement is the process of calculating and determining the net financial position of each member for all transactions that are cleared. The actual exchange of funds is a separate process.

In at least some implementations, the system may include one or more processors (e.g., digital signal processors, microprocessors, etc.), each being adapted to execute instructions to perform at least some of the methods, operations, and processes described herein with respect to the figures. Such instructions may be stored or held in storage media as instructions. Moreover, a non-transient computer readable medium can include such software as instructions executed by hardware to perform steps of methods described herein.

The methodologies described herein may be implemented in different ways and with different configurations depending upon the particular application. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

The herein described databases for storage media may comprise primary, secondary, and/or tertiary storage media. Primary storage media may include memory such as random access memory and/or read-only memory, for example. Secondary storage media may include a mass storage such as a magnetic or solid-state hard drive. Tertiary storage media may include removable storage media such as a magnetic or optical disk, a magnetic tape, a solid-state storage device, etc. In certain implementations, the storage media or portions thereof may be operatively receptive of, or otherwise configurable to couple to, other components of a computing platform, such as a processor.

In at least some implementations, one or more portions of the herein described storage media may store signals representative of data and/or information as expressed by a particular state of the storage media. For example, an electronic signal representative of data and/or information may be “stored” in a portion of the storage media (e.g., memory) by affecting or changing the state of such portions of the storage media to represent data and/or information as binary information (e.g., ones and zeros). As such, in a particular implementation, such a change of state of the portion of the storage media to store a signal representative of data and/or information constitutes a transformation of storage media to a different state or thing.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels.

Unless specifically stated otherwise, as apparent from the following discussion, it is appreciated that throughout this specification discussions utilizing terms such as “processing,” “computing,” “calculating,”, “identifying”, “determining”, “establishing”, “obtaining”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general-purpose computer once it is programmed to perform particular functions pursuant to instructions from program software.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in some implementations” or other like phrases in various places throughout this specification are not necessarily all referring to the same feature, example, and/or limitation. Furthermore, the particular features, structures, or characteristics may be combined in one or more examples and/or features.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes. Based on the disclosure and teachings provided herein, a person of ordinary skill in the art will appreciate other ways and/or methods for various implements. Moreover, it is understood that a functional step of described methods or processes, and combinations thereof can be implemented by computer program instructions that, when executed by a processor, create means for implementing the functional steps. The instructions may be included in non-transitory computer readable medium that can be loaded onto a general-purpose computer, a special purpose computer, or other programmable apparatus.

In the preceding detailed description, numerous specific details have been set forth to provide a thorough understanding of claimed subject matter. However, it will be understood by those skilled in the art that claimed subject matter may be practiced without these specific details. In other instances, methods and systems that would be known by one of ordinary skill have not been described in detail so as not to obscure claimed subject matter.

What is claimed is:

1. A method comprising a plurality of steps each being performed by hardware executing software, wherein the steps include:
receiving information derived from an authorization response for a transaction with a merchant conducted on an account issued to an account holder on an account, wherein the information includes:
the date and time of the transaction;
a currency amount of the transaction; and
identifiers for the merchant and the account holder;
accessing one or more databases:
using the identifiers for the merchant and the account holder to look-up information corresponding to the respective communities of the account holder and the merchant;
using the identifier for the merchant to look-up information corresponding to:
a business rule by which the merchant will make a donation to an affinity entity using the identifier for the merchant;
the logical address of the merchant using the identifier for the merchant;
and
using the identifier for the account holder to look-up information corresponding to an identifier of the affinity entity; and
for each said transaction for which the respective communities of the account holder and the merchant match:
deriving, using the business rule, the donation to be made by the merchant to the affinity entity; and
transmitting a message to a logical address containing the donation to be made by the merchant to the affinity entity.

2. The method as defined in claim 1, wherein the steps further comprise, a predetermined time period after the date of the transaction:
receiving a plurality of donation receipts each including:
the respective identifiers for the merchant and the affinity entity; and
a currency amount;
deriving the sum of the currency amounts of the donation receipts for the affinity entity;
determining a difference between:
the sum of the currency amounts of the donation receipts that were transmitted to the logical address of the merchant for the affinity entity; and
the sum of the currency amounts of the donation receipts that were received for the affinity entity for the merchant;
and
transmitting the determined difference to a logical address.

3. The method as defined in claim 2, wherein the logical address to which the message and the determined difference are transmitted is selected from the group consisting of:
a logical address for the merchant;
a logical address for the account holder;
a logical address of the affinity entity; and
a combination thereof.

4. The method as defined in claim 1, wherein:
each said transaction occurs in a system that includes a plurality of said merchants each conducting transaction on a respective said account issued to a respective said account holder by a respective issuer;
each said transaction on each said account is acquired for clearing and settlement by an acquirer for each said merchant through a transaction handler in communication with both the issuer of the account and the acquirer for the merchant; and
the issuer sends a corresponding said authorization response for the transaction to the merchant through the transaction handler and the acquirer in response to an authorization request sent to the issuer from the merchant through the transaction handler and the acquirer.

5. The method as defined in claim 1, wherein the steps further comprise using the information corresponding to the respective communities of the account holder and the merchant to derive whether the respective communities of the account holder and the merchant match.

6. The method as defined in claim 1, wherein:
the derivation of the match is performed by using the information corresponding to the respective communities of the account holder and the merchant to determine that the account holder and the merchant have the same community; and
the same community is selected from the group consisting of the same province, the same state, the same county in the same state, the same prefecture, the same city in the same state, the same city-state, the same borough in the same city, the same postal code for the delivery of posted mail, and combinations thereof.

7. The method as defined in claim 1, wherein:
the information corresponding to the respective communities of the account holder and the merchant includes respective geographic locations for the account holder and the merchant;
the derivation of the match is performed by using a navigation algorithm and the respective geographic locations for the account holder and the merchant;
the navigation algorithm computes a navigation time between from the respective geographic locations for the account holder and the merchant; and
the navigation time is computed to be below a predetermined maximum in order for the respective communities of the account holder and the merchant to match; and
the navigation time is computed for a transportation mode selected from the group consisting of walking, automobile, bicycle, mass transit, and a combination thereof.

8. The method as defined in claim 1, wherein the steps further comprise retrieving, using at least one of the respective merchant, account holder, and affinity entity identifiers, a logical address selected from the group consisting of:
the logical address of the merchant;
the logical address of the account holder;
the logical address of the affinity entity; and
a combination thereof.

9. The method as defined in claim 2, wherein the derivation of the donation to be made by the merchant to the affinity entity for the predetermined time period using the respective account holder and merchant donation business rules is a function, at least in part, of the received currency amount.

10. A non-transient computer readable medium comprising software executed by hardware to perform the steps of the method as defined in claim 1.

11. A method comprising a plurality of steps each being performed by hardware executing software, wherein the steps include:
for each of a plurality of transactions conducted by respective merchants and account holders, receiving information derived from an authorization response for the transaction and including the date and the time, a currency amount, and an identifier for the merchant;
for each said transaction for which the date and time of the corresponding said authorization response are within a predetermined time period:
for each said identifier for the merchant;
deriving the sum of the currency amounts;
using the identifier for the merchant to access a database to retrieve a business rule for making a donation corresponding to an identifier for an affinity entity having a logical address, wherein in the donation is a function, at least in part, of the sum of the currency amounts;
deriving, using the business rule and the sum of the currency amounts, the donation;
and
transmitting a message to a logical address containing the donation to be made by the merchant to the affinity entity for the predetermined time period;
within a predetermined audit time period for and after the predetermined time period:
receiving a plurality of donation receipts each including:
the respective identifiers for the affinity entity and the merchant; and
a currency amount;
and
for each said identifier for the merchant, deriving the sum of the currency amounts of the donation receipts for each said identifier for the affinity entity.

12. The method as defined in claim 11, wherein the steps further comprise:
after the predetermined audit time period for the predetermined time:
for each said identifier for the merchant:
for each said identifier corresponding to each said affinity entity to whom a donation was to be made as per the retrieved business rule:
determining a difference between:
the donation for the predetermined time period that was transmitted to the logical address of the merchant; and
the sum of the currency amounts of the donation receipts received for the affinity entity for the predetermined time period;
and
transmitting a message to a logical address containing the determined difference for the predetermined time period.

13. The method as defined in claim 11, wherein the logical address containing the donation to be made by the merchant to the affinity entity for the predetermined time period is selected from the group consisting of:
a logical address of the merchant;
a logical address of the account holder;
a logical address of the affinity entity; and
a combination thereof.

14. The method as defined in claim 11, wherein:
each said transaction occurs in a payment processing system of a plurality of merchants conducting the transactions on respective accounts issued to respective account holders by respective issuers;
each said transaction on each said account is acquired for clearing and settlement by an acquirer for the merchant through a transaction handler in communication with both the issuer of the account and the acquirer for the merchant, and
the issuer sends the authorization response for the transaction to the merchant through the transaction handler and the acquirer in response to an authorization request sent to the issuer from the merchant through the transaction handler and the acquirer.

15. A non-transient computer readable medium comprising software instructions executed by hardware to perform the steps of the method as defined in claim 11.

16. A method comprising a plurality of steps each being performed by hardware executing software, wherein the steps include:
for each of a plurality of transactions conducted by respective merchants and account holders, receiving information derived from an authorization response for the transaction and including the date and the time, a currency amount, and respective identifiers for the merchant and the account holder;
for each said transaction for which the date and time of the corresponding said authorization response are within a predetermined time period:
using the identifier for the merchant to access a database to retrieve a geographic location of the merchant corresponding to the identifier for the merchant; and
for each said transaction for which the geographic location of the merchant corresponding to the identifier for the merchant is within a predetermined geographically designated community:
for each said identifier for the merchant;
deriving the sum of the currency amounts;
using the identifier for the merchant to access a database to retrieve:
the logical address for the merchant corresponding to the identifier for the merchant;
a business rule for making a donation that is a function,
at least in part, of the sum of the currency amounts;
using the identifier for the account holder to access a database to retrieve a business rule for making a donation corresponding to one or more identifiers for one or more affinity entities, each said affinity entity having a logical address;
deriving, using the sum of the currency amounts and the retrieved business rules for the merchant and account holder, the respective donation corresponding to the one or more identifiers for one or more affinity entities; and
transmitting, to a logical address for the acquirer for the merchant:
the identifier for the merchant; and
the respective donation corresponding to the one or more identifiers for one or more affinity entities for the predetermined time period;
within a predetermined audit time period for and after the predetermined time period:
receiving a plurality of donation receipts each including:
the respective identifiers for the affinity entity within the predetermined geographically designated community of the acquirer; and
a currency amount; and
for each said identifier for the merchant, deriving the sum of the currency amounts of the donation receipts corresponding to each said affinity entity within the predetermined geographically designated community.

17. The method as defined in claim 16, wherein the steps further comprise:
after the predetermined audit time period for the predetermined time period:
for each said logical address of the acquirer:
for each said identifier of the affinity entity within the predetermined geographically designated community to whom a donation was to be made:
determining a difference between:
the donations for the predetermined time period that were transmitted to the logical address of the acquirer; and
the sum of the currency amounts of the donation receipts received for the affinity entity for the predetermined time period for the merchants corresponding to the acquirer; and
transmitting the determined difference to the logical address of the acquirer.

18. The method as defined in claim 16, wherein the steps further comprise transmitting the respective donation corresponding to the one or more identifiers for one or more affinity entities for the predetermined time period to a logical address selected from the group consisting of:
a logical address of the merchant;
a logical address of the account holder;
a logical address of the affinity entity; and
a combination thereof.

19. The method as defined in claim 16, wherein:
each said transaction occurs in a payment processing system having a plurality of said merchants conducting said transactions on respective accounts issued to respective said account holders by respective issuers;
each said transaction on each said account is acquired for clearing and settlement by an acquirer for the merchant through a transaction handler in communication with both the issuer of the account and the acquirer for the merchant, and
the issuer sends the authorization response for the transaction to the merchant through the transaction handler and the acquirer in response to an authorization request sent to the issuer from the merchant through the transaction handler and the acquirer.

20. A non-transient computer readable medium comprising software instructions executed by hardware to perform the steps of the method as defined in claim 16.
